(19) United States
(12) Patent Application Publication
(10) Pub. No.: US 2025/0341659 A1
(43) Pub. Date: Nov. 6, 2025

(54) OPTICAL ELEMENT AND EQUIPMENT

(71) Applicant: CANON KABUSHIKI KAISHA, Tokyo (JP)

(72) Inventors: ATSUSHI TAKATA, Kanagawa (JP); KAZUHIRO KOCHI, Kanagawa (JP); YUTA ITAHASHI, Saitama (JP); KEIICHIRO ISHIHARA, Saitama (JP); AKIRA YAMAMOTO, Saitama (JP); TAKAHITO CHIBANA, Tochigi (JP)

(21) Appl. No.: 19/184,667

(22) Filed: Apr. 21, 2025

Related U.S. Application Data
(63) Continuation of application No. PCT/JP2023/038828, filed on Oct. 27, 2023.

(30) Foreign Application Priority Data
Oct. 28, 2022 (JP) 2022-173225
Jun. 23, 2023 (JP) 2023-103414
Jun. 30, 2023 (JP) 2023-107672
Jul. 5, 2023 (JP) 2023-110813

(51) Int. Cl. G02B 5/124

(52) U.S. Cl. CPC G02B 5/124

(57) ABSTRACT

An optical element includes a mirror array and an optical surface opposed to the mirror array. The mirror array includes a mirror group including a plurality of retroreflective mirrors arranged in an X direction, and a mirror group including a plurality of retroreflective mirrors arranged in the X direction. The mirror group and the mirror group are juxtaposed in a Y direction. The plurality of retroreflective mirrors of the mirror group extends along a W1 direction oblique to the optical surface. The plurality of retroreflective mirror of the mirror group extends along a W2 direction oblique to the optical surface. The mirror group and the mirror group overlap in part in a V1 direction.

### CROSS-REFERENCE TO RELATED APPLICATIONS

This application is a Continuation of International Patent Application No. PCT/JP2023/038828, filed Oct. 27, 2023, which claims the benefit of Japanese Patent Applications No. 2022-173225, filed Oct. 28, 2022, No. 2023-103414, filed Jun. 23, 2023, No. 2023-107672, filed Jun. 30, 2023, and No. 2023-110813, filed Jul. 5, 2023, all of which are hereby incorporated by reference herein in their entirety.

### BACKGROUND OF THE INVENTION

### Field of the Invention

The present invention relates to an optical element including a mirror array.

### Background Art

Display and imaging can be performed by controlling light using an optical element including a reflection optical system. Patent Literature 1 discusses a light guide for a virtual image display device, which guides image light from an image display element and emits the image light to display a virtual image, the light guide including a retroreflective portion for reversing the traveling direction of the image light guided inside a light guide member of the light guide. Patent Literature 2 discusses a light guide device used in a display device, the light guide device including a plurality of half mirrors between a first light guide and a second light guide.

### CITATION LIST

### Patent Literature

PTL 1: Japanese Patent Laid-Open No. 2018-132602
PTL 2: Japanese Patent Laid-Open No. 2019-066813

### SUMMARY OF THE INVENTION

The technique of Patent Literature 1 has room for improvement in miniaturizing the light guide and enhancing optical performance. The technique of Patent Literature 2 has room for improvement in enhancing the optical performance of the light guide device. The present invention is thus directed to providing a technique advantageous for implementing a compact optical element with high optical performance.

First means for solving the problem is an optical element including a mirror array, and an optical surface opposed to the mirror array, wherein the mirror array includes a first mirror group including a plurality of retroreflective mirrors arranged in a first direction, and a second mirror group including a plurality of retroreflective mirrors arranged in the first direction, wherein the first mirror group and the second mirror group are juxtaposed in a second direction intersecting the first direction, wherein the plurality of retroreflective mirrors of the first mirror group extends along a third direction that intersects the first and second directions and is oblique to the optical surface, wherein the plurality of retroreflective mirrors of the second mirror group extends along a fourth direction that intersects the first and second directions and is oblique to the first surface, and wherein the first mirror group and the second mirror group overlap in part in a fifth direction orthogonal to the first and third directions.

Second means for solving the problem is an optical element including a mirror array, a first optical surface opposed to the mirror array, and a second optical surface opposed to the mirror array, wherein the mirror array includes a mirror group located between the first optical surface and the second optical surface, the mirror group including a plurality of retroreflective mirrors arranged in a first direction, and wherein the plurality of retroreflective mirrors of the mirror group extends along a second direction that intersects the first direction and is oblique to the first and second optical surfaces.

Third means for solving the problem is an optical element including a mirror array, and an optical surface opposed to the mirror array, wherein the mirror array includes a first transparent mirror, and a second transparent mirror, wherein the first transparent mirror extends along a first direction oblique to the optical surface, wherein the second transparent mirror extends along a second direction oblique to the optical surface, wherein in a third direction intersecting the optical surface and the first direction, the first transparent mirror is located between the second transparent mirror and the optical surface, a first portion of the first transparent mirror and a first portion of the second transparent mirror overlap, a second portion of the first transparent mirror does not overlap the second transparent mirror, and a second portion of the second transparent mirror does not overlap the first transparent mirror, and wherein at least either that the first portion of the first transparent mirror has a reflectance lower than that of the second portion of the first transparent mirror or that the first portion of the second transparent mirror has a reflectance lower than that of the second portion of the second transparent mirror is satisfied.

According to the present invention, a technique advantageous for implementing a compact optical element with high optical performance can be provided.

Further features of the present invention will become apparent from the following description of exemplary embodiments with reference to the attached drawings.

### BRIEF DESCRIPTION OF THE DRAWINGS

FIG. 1A is a schematic diagram for describing an optical element.

FIG. 1B is a schematic diagram for describing an optical element.

FIG. 1C is a schematic diagram for describing an optical element.

FIG. 1D is a schematic diagram for describing an optical element.

FIG. 2A is a schematic diagram for describing an optical element.

FIG. 2B is a schematic diagram for describing an optical element.

FIG. 2C is a schematic diagram for describing an optical element.

FIG. 2D is a schematic diagram for describing an optical element.

FIG. 3A is a schematic diagram for describing an optical element.

FIG. 3B is a schematic diagram for describing an optical element.

FIG. 3C is a schematic diagram for describing an optical element.

FIG. 4A is a schematic diagram for describing an optical element.

FIG. 4B-1 is a schematic diagram for describing an optical element.

FIG. 4B-2 is a schematic diagram for describing an optical element.

FIG. 4C-1 is a schematic diagram for describing an optical element.

FIG. 4C-2 is a schematic diagram for describing an optical element.

FIG. 5A is a schematic diagram for describing an optical element.

FIG. 5B is a schematic diagram for describing an optical element.

FIG. 5C is a schematic diagram for describing an optical element.

FIG. 5D is a schematic diagram for describing an optical element.

FIG. 6A is a schematic diagram for describing a display device.

FIG. 6B is a schematic diagram for describing the display device.

FIG. 7A is a schematic diagram for describing an optical element.

FIG. 7B is a schematic diagram for describing an optical element.

FIG. 8A is a schematic diagram for describing an optical element.

FIG. 8B is a schematic diagram for describing an optical element.

FIG. 9A is a schematic diagram for describing an optical element.

FIG. 9B is a schematic diagram for describing an optical element.

FIG. 10A is a schematic diagram for describing an optical element.

FIG. 10B is a schematic diagram for describing an optical element.

FIG. 11 is a schematic diagram for describing an optical element.

FIG. 12A is a schematic diagram for describing an optical element.

FIG. 12B is a schematic diagram for describing an optical element.

FIG. 12C is a schematic diagram for describing an optical element.

FIG. 12D is a schematic diagram for describing an optical element.

FIG. 13A is a schematic diagram for describing an optical element.

FIG. 13B is a schematic diagram for describing an optical element.

FIG. 13C is a schematic diagram for describing an optical element.

FIG. 13D is a schematic diagram for describing an optical element.

FIG. 14A is a schematic diagram for describing an optical element.

FIG. 14B is a schematic diagram for describing an optical element.

FIG. 14C is a schematic diagram for describing an optical element.

FIG. 14D is a schematic diagram for describing an optical element.

FIG. 15A is a schematic diagram for describing an optical element.

FIG. 15B is a schematic diagram for describing an optical element.

FIG. 15C is a schematic diagram for describing an optical element.

FIG. 15D is a schematic diagram for describing an optical element.

FIG. 16A is a schematic diagram for describing an optical element.

FIG. 16B is a schematic diagram for describing an optical element.

FIG. 16C is a schematic diagram for describing an optical element.

FIG. 16D is a schematic diagram for describing an optical element.

FIG. 17A is a schematic diagram for describing an optical element.

FIG. 17B is a schematic diagram for describing an optical element.

FIG. 17C is a schematic diagram for describing an optical element.

FIG. 18A is a schematic diagram for describing an optical element.

FIG. 18B is a schematic diagram for describing an optical element.

FIG. 18C is a schematic diagram for describing an optical element.

FIG. 18D is a schematic diagram for describing an optical element.

FIG. 19A is a schematic diagram for describing an optical element.

FIG. 19B is a schematic diagram for describing an optical element.

FIG. 19C is a schematic diagram for describing an optical element.

FIG. 19D is a schematic diagram for describing an optical element.

FIG. 20A is a schematic diagram for describing an optical element.

FIG. 20B is a schematic diagram for describing an optical element.

FIG. 21A is a schematic diagram for describing equipment.

FIG. 21B is a schematic diagram for describing equipment.

FIG. 21C is a schematic diagram for describing equipment.

### DESCRIPTION OF THE EMBODIMENTS

Exemplary embodiments for carrying out the present invention will be described below with reference to the drawings. In the following description and the drawings, components common to a plurality of drawings are denoted by common reference numerals. The common components will therefore be described with cross-reference to the plurality of drawings, and a description of components denoted by the common reference numerals will be omitted as appropriate. Separate components to be referred to by the same names can be distinguished by adding ordinal numbers, such as a first component and a second component.

### First Exemplary Embodiment

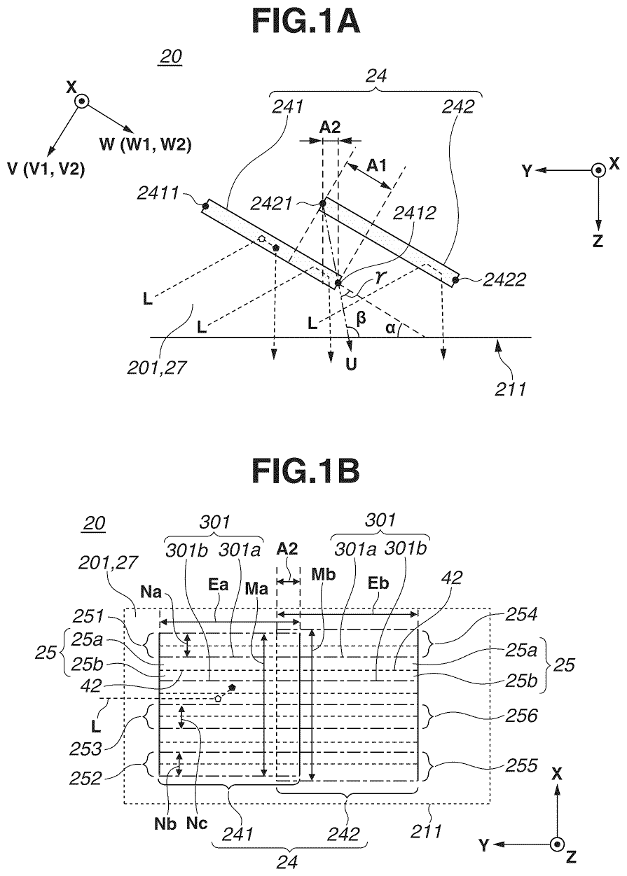

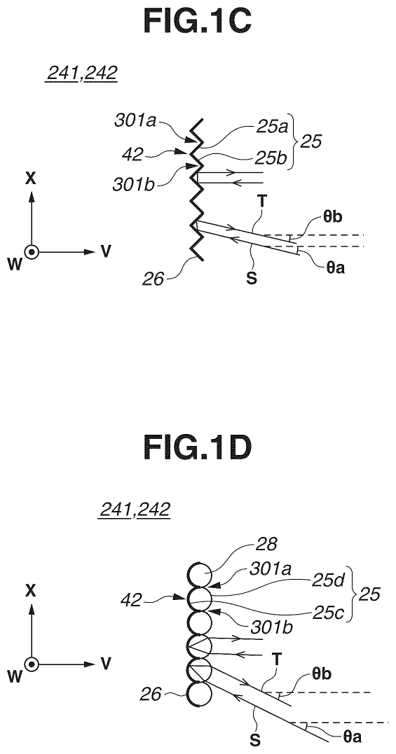

An optical element 20 according to a first exemplary embodiment will be described with reference to FIGS. 1A to 1D. FIG. 1A is a sectional view of the optical element 20 in a Y-Z plane. FIG. 1B is a plan view of the optical element 20 in an X-Y plane.

The optical element 20 includes a mirror array 24 and an optical surface 211 opposed to the mirror array 24. The optical surface 211 is an optical surface having light transparency and light reflectivity. An optical surface having light transparency can be referred to as a transparent surface. An optical surface having light reflectivity can be referred to as a reflecting surface. The mirror array 24 includes a mirror group 241 and a mirror group 242. As illustrated in FIG. 1B, the mirror group 241 includes a plurality of retroreflective mirrors 25 arranged in the X direction. While FIG. 1B illustrates three retroreflective mirrors 251, 252, and 253 out of six retroreflective mirrors 25 with the respective different reference numerals, the retroreflective mirrors 251, 252, and 253 are all examples of the retroreflective mirrors 25. As illustrated in FIG. 1B, the mirror group 242 includes a plurality of retroreflective mirrors 25 arranged in the X direction. While FIG. 1B illustrates three retroreflective mirrors 254, 255, and 256 out of six retroreflective mirrors 25 with the respective different reference numerals, the retroreflective mirrors 254, 255, and 256 are all examples of the retroreflective mirrors 25. The mirror group 241 and the mirror group 242 are juxtaposed in the Y direction intersecting the X direction. The Y direction is typically orthogonal to the X direction, but the Y direction may be oblique to the X direction.

As illustrated in FIG. 1B, the plurality of retroreflective mirrors 25 of the mirror group 241 extends obliquely to the optical surface 211, along a W1 direction intersecting the X and Y directions. In other words, the W1 direction in which the plurality of retroreflective mirrors 25 of the mirror group 241 extends is oblique to the optical surface 211. The W1 direction is typically orthogonal to the X direction, but the W1 direction may be oblique to the X direction. The plurality of retroreflective mirrors 25 of the mirror group 242 extends obliquely to the optical surface 211, along a W2 direction intersecting the X and Y directions. In other words, the W2 direction in which the plurality of retroreflective mirrors 25 of the mirror group 242 extends is oblique to the optical surface 211. The W2 direction is typically orthogonal to the X direction, but the W2 direction may be oblique to the X direction. The W2 direction is typically parallel to the W1 direction, but the W2 direction may be oblique to the W1 direction. The W1 direction and the W2 direction can be referred to collectively as a W direction, regardless of whether the W2 direction is parallel or non-parallel to the W1 direction.

Assuming an imaginary plane along the X direction in which the retroreflective mirrors 25 of the mirror group 241 is arranged and the W1 direction in which the mirror group 241 extends as a modeled reflecting surface of the mirror group 241, a direction normal to this modeled reflecting surface can be defined as a V1 direction orthogonal to the X and W1 directions. Assuming an imaginary plane along the X direction in which the retroreflective mirrors 25 of the mirror group 242 is arranged and the W2 direction in which the mirror group 242 extends as a modeled reflecting surface of the mirror group 242, a direction normal to this modeled reflecting surface can be defined as a V2 direction orthogonal to the X and W2 directions. The V2 direction is typically parallel to the V1 direction, but the V2 direction may be oblique to the V1 direction. The V1 direction and the V2 direction can be referred to collectively as a V direction, regardless of whether the V2 direction is parallel or non-parallel to the V1 direction.

In the V1 direction orthogonal to the X and W1 directions, the mirror groups 241 and 242 overlap in part. In the V2 direction orthogonal to the X and W2 directions, the mirror groups 241 and 242 overlap in part. FIG. 1A illustrates an overlapping region A1 of the mirror groups 241 and 242 in the V1 direction and/or the V2 direction.

In the Z direction orthogonal to the optical surface 211, the mirror groups 241 and 242 desirably overlap in part. FIGS. 1A and 1B illustrate an overlapping region A2 of the mirror groups 241 and 242 in the Z direction. The Z direction is typically orthogonal to the X direction, but the Z direction may be oblique to the X direction. The Z direction is typically orthogonal to the Y direction, but the Z direction may be oblique to the Y direction. The optical surface 211 may be a curved surface, in which case a direction normal to the curved surface can be set as the Z direction. Tangential directions tangential to the curved surface may be set as the X and Y directions.

The direction (X direction) in which the retroreflective mirrors 25 are arranged can be referred to as an arrangement direction. The direction (Y direction) in which the mirror groups 241 and 242 are juxtaposed can be referred to as a juxtaposition direction. The direction (Z direction) perpendicular to the optical surface 211 can be referred to as a perpendicular direction. The direction (W direction) in which the retroreflective mirrors 25 extend can be referred to as an extension direction. The direction (V direction) orthogonal to the arrangement direction (X direction) and the extension direction (W direction) can be referred to as an orthogonal direction.

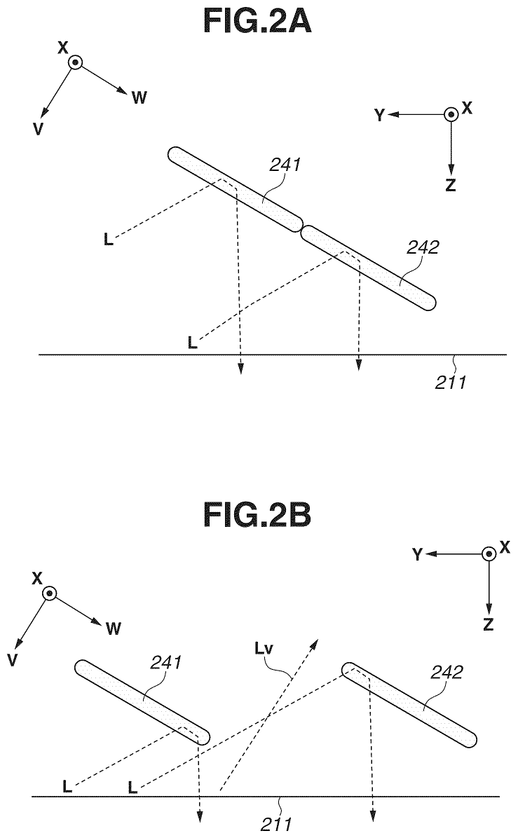

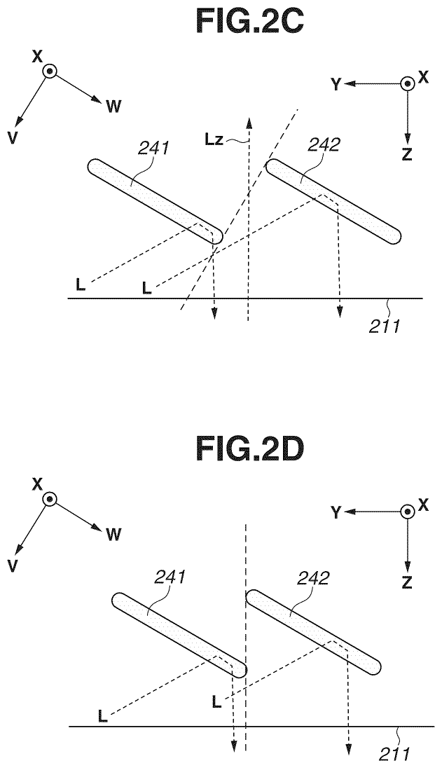

Advantages of the foregoing mirror array 24 will be described with reference to FIGS. 2A to 2D.

In the configuration of FIG. 2A, the mirror groups 241 and 242 are situated oblique to the optical surface 211. This can give the mirror array 24 a retroreflective function as well as a reflective function toward the optical surface 211, and the optical element 20 can be miniaturized in the Y direction. The mirror groups 241 and 242 are juxtaposed in the W direction and offset in the Z direction. The thickness of the optical element 20 in the Z direction therefore increases.

In the configuration of FIG. 2B, the mirror groups 241 and 242 are juxtaposed in the Y direction, and the thickness of the optical element 20 in the Z direction can thus be reduced compared to the configuration of FIG. 2A. However, this configuration facilitates the occurrence of stray light Lv in the V direction, which passes through between the mirror groups 241 and 242.

The configuration of FIG. 2C is a boundary case between the example where the mirror groups 241 and 242 overlap in part in the V direction and the example where the mirror groups 242 and 242 do not overlap in part in the V direction. In the configuration of FIG. 2C, the stray light Lv as in FIG. 2B can be prevented. However, the configuration of FIG. 2C facilitates the occurrence of stray light Lz in the Z direction, which passes through between the mirror groups 241 and 242.

The configuration of FIG. 2D is a boundary case between the example where the mirror groups 241 and 242 overlap in part in the Z direction and the example where the mirror groups 241 and 242 do not overlap in part in the Z direction. In the configuration of FIG. 2D, the stray light Lz in the Z direction as in FIG. 2C can be prevented.

FIGS. 1C and 1D illustrate examples of the shape of the mirror group 241 seen in the W1 or the mirror group 242 seen in the W2 direction. A retroreflective mirror 25 will be described with reference to FIGS. 1C and 1D. Now, focus attention on the X direction and the V direction to which the W direction is orthogonal. The incident angle of incident light that is incident in an S direction (incident direction) oblique to the V direction will be denoted by θa. θa is 10° or more, preferably 20° or more, yet preferably 30° or more. θa is 80° or less, preferably 70° or less, yet preferably 60° or less. Reflected light that is the incident light reflected at the retroreflective mirror 25 shall be reflected in a T direction (reflected direction) at an angle of θb relative to the V direction. If an angle θc formed between the S direction (incident direction) and the T direction (reflected direction) is less than 2×θa (θc<2×θa), the X-direction components of the incident light and the reflection light can be said to be retroreflective in the X direction. On non-retroreflective mirrors such as plane mirrors, the angle θc formed between the S direction (incident direction) and the T direction (reflected direction) is θc=θa+θb. Since θa=θb, the result is θc=2×θa=2×θb. The angle θc formed between the S direction (incident direction) and the T direction (reflected direction) on the retroreflective mirror 25 is preferably less than θa (θc<θa), more preferably less than θb/2(θc<θa/2). In the examples of FIGS. 1C and 1D, θa=θb and θc=0°, and θc is thus omitted. Since the retroreflective mirror 25 extends in the W direction, the retroreflectivity of the retroreflective mirror 25 in the W direction is weaker than the retroreflectivity in the X direction. That the retroreflectivity in the W direction is weak includes situations where there is no retroreflectivity in the W direction. The magnitudes of the retroreflectivity in the X and W directions can be evaluated by dividing the foregoing S and T directions into X- and W-direction components, and comparing the angle formed between the incident and reflected directions of the X-direction components with the angle formed between the incident and reflected directions of the W-direction components. The smaller the angle formed between the incident and reflected directions of the direction components, the higher the retroreflectivity can be evaluated to be.

In the example of FIG. 1C, the retroreflective mirror 25 includes a pair of reflecting surfaces 25a and 25b that are non-parallel to each other and opposed to each other in the X direction. Such a retroreflective mirror 25 can be referred to as a triangular mirror. The angle formed between the pair of reflecting surfaces 25a and 25b is 45° to 135°, for example, and typically 90°. A retroreflective mirror 25 where the angle formed between the reflecting surfaces 25a and 25b is 90°±10° can be referred to as a right-angle mirror. The angle formed between the reflecting surfaces 25a and 25b is not limited to the right angle, and may be an acute angle or an obtuse angle. The reflecting surfaces 25a and 25b are formed by a reflective body 26. The mirror group 241 includes a plurality of retroreflective mirrors 25 each including such a pair of reflecting surfaces 25a and 25b, arranged in the X direction. Similarly, the mirror group 242 includes a plurality of retroreflective mirrors 25 each including such a pair of reflecting surfaces 25a and 25b, arranged in the X direction. In FIGS. 1B and 1C, six retroreflective mirrors 25 are arranged in the X direction. As seen in the Z direction or the V direction, the boundaries between adjacent retroreflective mirrors 25 are ridge lines 301a and 301b. The ridge lines 301a and 301b can be referred to collectively as ridge lines 301. The boundaries between the reflecting surfaces 25a and the reflecting surfaces 25b are valley lines 42. In FIG. 1B, the ridge lines 301a and 301b are illustrated in dotted dashed lines, and the valley lines 42 are illustrated in dotted lines. The reflecting surfaces 25a and 25b, the ridge lines 301a and 301b, and the valley lines 42 extend along the W direction (W1 direction or W2 direction).

In the example of FIG. 1D, a retroreflective mirror 25 includes a reflecting surface 25c curved in a semicircular shape and a refractive surface 25d curved in a semicircular shape. A refractive body 28 is located between the reflecting surface 25c and the refractive surface 25d. The reflecting surface 25c is constituted by a reflective body 26, and the refractive surface 25d is constituted by the refractive body 28. The mirror group 241 includes a plurality of retroreflective mirrors 25 each including such a pair of reflecting surface 25c and refractive surface 25d, arranged in the X direction. Similarly, the mirror group 242 includes a plurality of retroreflective mirrors 25 each including such a pair of reflecting surface 25c and refractive surface 25d, arranged in the X direction. In FIGS. 1B and 1D, six retroreflective mirrors 25 are arranged in the X direction. As seen in the Z direction or the V direction, the boundaries between adjacent retroreflective mirrors 25 are ridge lines 301a and 301b. The bottoms of the reflecting surfaces 25c are valley lines 42. The reflecting surfaces 25c, the refractive surfaces 25d, the ridge lines 301a and 301b, and the valley lines 42 extend along the W direction (W1 direction or W2 direction). The refractive bodies 28 have a cylindrical shape and extend in the W direction.

In the retroreflective mirrors 25 of FIG. 1C or 1D, the reflective body 26 can contain metal material (including alloys) and/or dielectric material. The reflective body 26 may contain a plurality of types of metal materials and/or dielectric materials. The reflective body 26 may be a dielectric multilayer film including low- and high-refractive-index dielectric materials alternately stacked. Examples of the low-refractive-index dielectric material include silicon oxide, magnesium fluoride, magnesium oxide, aluminum oxide, and aluminum fluoride. Examples of the high-refractive-index dielectric material include silicon nitride, titanium oxide, hafnium oxide, zirconium oxide, zirconium oxide, tantalum oxide, and niobium oxide.

The retroreflective mirrors 25 may have transparency. The retroreflective mirrors 25 having transparency can transmit light having the same wavelength as that of light for the retroreflective mirrors 25 to reflect. For example, the reflective body 26 of the retroreflective mirrors 25 may reflect and transmit visible light. The optical characteristics of the retroreflective mirrors 25 having transparency can be such that at a specific wavelength, the reflectance is 5% to 95% and the transmittance is 5% to 95%. The optical characteristics of the retroreflective mirrors 25 having transparency are preferably such that at a specific wavelength, the reflectance is 10% to 90% and the transmittance is 10% to 90%. The optical characteristics of the retroreflective mirrors 25 having transparency are more preferably such that at a specific wavelength, the reflectance is 25% to 75% and the transmittance is 25% to 75%. The specific wavelength typically refers to a wavelength of visible light, and may be a wavelength within one of the ranges of 555±100 nm, 555±50 nm, and 555±10 nm, for example. The retroreflective mirrors 25 having transparency can transmit light having a wavelength different from that of light for the retroreflective mirrors 25 to reflect. For example, the reflective body 26 of the retroreflective mirrors 25 can reflect visible light and transmit ultraviolet rays or infrared rays. The retroreflective mirrors 25 having transparency can be implemented by adjusting the light transmittance and light reflectance of the reflective body 26, by adjusting the material and thickness of the reflective body 26. The retroreflective mirrors 25 having transparency may be magic mirrors, half mirrors, band-stop filters, band-pass filters, dichroic mirrors, etc.

As illustrated in FIGS. 1A and 1B, a base 201 having the optical surface 211 supports the reflective body 26 of the mirror array 24. The base 201 is a component constituting the optical element 20. The base 201 includes a transparent portion 27, and this transparent portion 27 supports the reflective body 26 of the mirror array 24. The light incident on and retroreflected at the retroreflective mirrors 25 propagates through this base 201 (transparent portion 27). For that purpose, the base 201 (transparent portion 27) can contain a transparent material. The base 201 can include portions interposed between the reflecting surfaces 25a and 25b in the X direction. If the reflective body 26 is a dielectric multilayer film, the refractive index of the high-refractive-index dielectric material included in the dielectric multilayer film of the reflective body 26 is desirably higher than that of the transparent portion 27, but may be lower than that of the transparent portion 27. The refractive index of the low-refractive-index dielectric material included in the dielectric multilayer film of the reflective body 26 is desirably lower than that of the transparent portion 27, but may be higher than that of the transparent portion 27. The transparent material constituting the base 201 (transparent portion 27) can be plastic or glass. Optical plastics such as acrylic resin, styrene resin, polyolefin resin, and polycarbonate can be used for the plastic as the transparent material. Such plastics have a refractive index of approximately 1.45 to 1.60. Cycloolefin polymers are particularly suitable as the plastic constituting the base 201. Cycloolefin polymers are suitable for improving the performance of the optical element 20 due to their high transparency, lightfastness, stability in refractive index and Abbe number, low birefringence, low specific gravity, high heat resistance, and precision moldability.

Aside from the transparent material constituting the transparent portion 27, the base 201 may also contain coating material that covers the transparent material constituting the transparent portion 27. Various materials for protection (scratch prevention and stain prevention), anti-reflection, and reflection enhancement purposes can be employed as the coating material. Transparent or light-shielding materials can be used as the coating material. The coating material may be inorganic or organic material. The coating material may constitute the optical surface 211 of the base 201.

While the mirror array 24 is described to be implemented using the reflective body 26, the reflective body 26 may be omitted and the mirror array 24 may be configured so that total internal reflection occurs at the inner surface of the base 201 (transparent portion 27). In such a case, the base 201 (transparent portion 27) can function like a prism. The same can apply to a cover 202 (transparent portion 37) to be described below.

Referring to FIGS. 1A and 1B, the behavior of rays L with respect to a single retroreflective mirror 25 including a pair of reflecting surfaces 25a and 25b will be described. For example, a ray L incident on the mirror group 241 with a W1-direction component is reflected at the reflecting surface 25b with an X-direction component, at the position of the hollow circle in FIGS. 1A and 1B. This ray L propagates between the reflecting surface 25a and the reflecting surface 25b, and is incident on the reflecting surface 25a at the position of the solid circle in FIGS. 1A and 1B. Since the ray L has the W1-direction component, the hollow circuit and the solid circle are at different positions in the W1 direction. The ray L is reflected with the W1-direction component reflected at the reflecting surface 25a, at the position of the solid circle in FIGS. 1A and 1B. The same applies to the mirror group 242.

If the mirror group 241 does not have retroreflectivity in the W1 direction, the angle (incident angle) that the incident direction of the ray L forms with the normal direction (V1 direction) of the modeled reflective plane of the mirror group 241 is equivalent to the angle (emission angle) that the emission direction of the ray L forms with the normal direction (V1 direction) of the modeled reflective plane of the mirror group 241. The angle formed between the incident direction of the ray L and the emission direction of the ray L is greater than the angle (incident angle) that the incident direction of the ray L forms with the normal direction (V1 direction) of the modeled reflective plane of the mirror group 241 and the angle (emission angle) that the emission direction of the ray L forms with the normal direction (V1 direction) of the modeled reflective plane of the mirror group 241. The same applies to the mirror group 242.

Here, the typical ray L is described to be reflected in the Z direction at the reflecting surface 25a. The reason is that it is useful in designing and evaluating the optical element 20 to set the case where the ray L is perpendicularly incident on the optical surface 211 as a representative example. However, in actually using the optical element 20, the ray L does not necessarily need to be perpendicularly incident on the optical surface 211.

The mirror group 241 may include a non-opposed surface (not illustrated) that is not opposed to the pair of reflecting surfaces 25a and 25b of at least one of the plurality of retroreflective mirrors 25 of the mirror group 241 in the X direction. The non-opposed surface desirably overlaps the mirror group 242 in the V1 direction. The non-opposed surface also desirably overlaps the mirror group 242 in the Z direction perpendicular to the optical surface 211.

The mirror group 242 may include a non-opposed surface (not illustrated) that is not opposed to the pair of reflecting surfaces 25a and 25b of at least one of the plurality of retroreflective mirrors 25 of the mirror group 242 in the X direction. The non-opposed surface desirably overlaps the mirror group 241 in the V2 direction. The non-opposed surface also desirably overlaps the mirror group 241 in the Z direction perpendicular to the optical surface 211.

In FIG. 1A, the W direction is illustrated in a dotted line. An angle α formed between the W direction illustrated in the dotted line and the optical surface 211 is desirably greater than 15° (α>) 15° and also desirably less than 60° (α<) 60°, preferably greater than 20° and less than 45° (20°<α<) 45°.

FIG. 1A illustrates an end 2412 of the mirror group 241 on the mirror group 242 side and an end 2411 of the mirror group 241 opposite to the mirror group 242. FIG. 1A also illustrates an end 2421 of the mirror group 242 on the mirror group 241 side and an end 2422 of the mirror group 242 opposite to the mirror group 241. The end 2421 of the mirror group 242 desirably overlaps the mirror group 241 in the V direction (V1 direction and/or V2 direction). The end 2412 of the mirror group 242 desirably overlaps the mirror group 241 in the V direction (V1 direction and/or V2 direction). The end 2421 of the mirror group 242 desirably overlaps the mirror group 241 in the Z direction. The end 2412 of the mirror group 242 desirably overlaps the mirror group 241 in the Z direction. This enables the mirror array 24 to appropriately reflect light incident near the ends 2412 and 2421.

In FIG. 1A, a U direction connecting the end 2412 of the mirror group 241 on the mirror group 242 side and the end 2421 of the mirror group 242 on the mirror group 241 side orthogonally to the X direction is illustrated in a double-dotted dashed line. An angle β that the U direction illustrated in the double-dotted dashed line forms with the optical surface 211 is desirably greater than 45° and less than 135° (45°<β<135°), preferably greater than 60° and less than 120° (60°<β<120°). For the mirror groups 241 and 242 to overlap in the Z direction, the angle β is desirably greater than 90° (β>90°). The angle β is thus desirably greater than 90° and less than 135° (90°<β<135°), preferably greater than 90° and less than 120° (90°<β<120°). An angle γ that the U direction illustrated in the double-dotted dashed line forms with the W direction is desirably greater than 15° and less than 70° (15°<γ<70°). As can be seen from FIG. 1A, the angles α, β, and γ constitute the angles of a triangle, and thus α+β+γ=180°. At least one of α<β, α<γ, and γ<β is desirably satisfied, preferably two, more preferably three. An example can be α=30°, β=105°, and γ=45°.

As illustrated in FIG. 1B, the plurality of retroreflective mirrors 25 of the mirror group 241 includes a retroreflective mirror 251, a retroreflective mirror 252, and a retroreflective mirror 253 that is located between the retroreflective mirrors 251 and 252 in the X direction. In FIG. 1B, the width Na of the retroreflective mirror 251 in the X direction, the width Nb of the retroreflective mirror 252, and the width Nc of the retroreflective mirror 253 in the X direction are the same (Na=Nb=Nc). However, the width Na of the retroreflective mirror 251 and the width Nb of the retroreflective mirror 252 in the X direction may be greater than the width Nc of the retroreflective mirror 253 in the X direction (Na>Nc and Nb>Nc). Alternatively, the width Na of the retroreflective mirror 251 and the width Nb of the retroreflective mirror 252 in the X direction may be smaller than the width Nc of the retroreflective mirror 253 in the X direction (Na<Nc and Nb<Nc). Alternatively, the width Nc of the retroreflective mirror 253 in the X direction may be intermediate between the width Na of the retroreflective mirror 251 and the width Nb of the retroreflective mirror 252 in the X direction (Na<Nc<Nb or Na>Nc>Nb).

The same applies to the plurality of retroreflective mirrors 25 of the mirror group 242. The plurality of retroreflective mirrors 25 of the mirror group 242 includes a retroreflective mirror 254, a retroreflective mirror 255, and a retroreflective mirror 256 that is located between the retroreflective mirrors 254 and 255 in the X direction. In FIG. 1B, the width of the retroreflective mirror 254 in the X direction, the width of the retroreflective mirror 255, and the width of the retroreflective mirror 256 in the X direction are the same. However, the width of the retroreflective mirror 254 and the width of the retroreflective mirror 255 in the X direction may be greater than or smaller than the width of the retroreflective mirror 256 in the X direction. Alternatively, the width of the retroreflective mirror 256 in the X direction may be intermediate between the width of the retroreflective mirror 254 and the width of the retroreflective mirror 255 in the X direction. The widths of the retroreflective mirrors 25 in the X direction are 0.1 to 0.5 mm, for example, or 0.5 to 2.5 mm, for example.

As illustrated in FIG. 1B, the width Mb of the mirror group 242 in the X direction may be greater than the width Ma of the mirror group 241 in the X direction (Ma<Mb). Even when light traveling from the +Y side to the −Y side spreads out in the X direction, the light can thus be reflected over a wider area. The width Mb of the mirror group 242 in the X direction may be smaller than the width Ma of the mirror group 241 in the X direction (Mb<Ma). The width Mb of the mirror group 242 in the X direction may be equal to the width Ma of the mirror group 241 in the X direction (Mb=Ma).

In FIG. 1B, the number of retroreflective mirrors 25 arranged in each of the mirror groups 241 and 242 is six. However, the number of retroreflective mirrors 25 may be 10 to 100, for example, or 15 to 60, for example. The number of retroreflective mirrors 25 in the mirror group 241 and the number of retroreflective mirrors 25 in the mirror group 242 may be the same or different. The number of retroreflective mirrors 25 in the mirror group 242 may be greater than or smaller than the number of retroreflective mirrors 25 in the mirror group 241.

The length Ea of the mirror group 241 in the W1 direction and the length Eb of the mirror group 242 in the W2 direction correspond to the ranges where the mirror groups 241 and 242 provide retroreflectivity (weak retroreflectivity) in the W direction. The length Ea of the mirror group 241 in the W1 direction and the length Eb of the mirror group 242 in the W2 direction correspond to the lengths of the ridge lines 301 and the valley lines 42 of the retroreflective mirrors 25. The length Ea of the mirror group 241 in the W1 direction and the length Eb of the mirror group 242 in the W2 direction can be said to be the extending distances of the retroreflective mirrors 25. The length Ea of the retroreflective mirrors 25 of the mirror group 241 in the W1 direction is desirably one time or more the width N (Na, Nb, or Nc) of the retroreflective mirrors 25 of the mirror group 241 in the X direction, and desirably greater than the width N (Na, Nb, or Nc) of the retroreflective mirrors 25 of the mirror group 241 in the X direction. The length Ea of the retroreflective mirrors 25 of the mirror group 241 in the W1 direction can be twice or more, or three times or more, the width N (for example, the width Na, Nb, or Nc) of the retroreflective mirrors 25 of the mirror group 241 in the X direction. The length Ea of the retroreflective mirrors 25 of the mirror group 241 in the W1 direction may be 10 times or less the width N (Na, Nb, or Nc) of the retroreflective mirrors 25 of the mirror group 241 in the X direction, and can be nine times or less, or eight times or less. The length Ea of the retroreflective mirrors 25 of the mirror group 241 in the W1 direction may be more than 10 times the width N (Na, Nb, or Nc) of the retroreflective mirrors 25 of the mirror group 241 in the X direction. This leads to an increase in the size of the optical element 20, however, and 10 times or less is thus preferable.

The length Eb of the retroreflective mirrors 25 of the mirror group 242 in the W2 direction is desirably one time or more the width N (Na, Nb, or Nc) of the retroreflective mirrors 25 of the mirror group 242 in the X direction, and desirably greater than the width N (Na, Nb, or Nc) of the retroreflective mirrors 25 of the retroreflective mirror group 242 in the X direction. The length Eb of the retroreflective mirrors 25 of the mirror group 242 in the W2 direction can be twice or more, or three times or more, the width N (for example, the width Na, Nb, or Nc) of the retroreflective mirrors 25 of the mirror group 242 in the X direction. The length Eb of the retroreflective mirrors 25 of the mirror group 242 in the W2 direction may be 10 times or less the width N (Na, Nb, or Nc) of the retroreflective mirrors 25 of the mirror group 242 in the X direction, and can be nine times or less, or eight times or less. The length Eb of the retroreflective mirrors 25 of the mirror group 242 in the W2 direction may be more than 10 times the width N (Na, Nb, or Nc) of the retroreflective mirrors 25 of the mirror group 242 in the X direction. This leads to an increase in the size of the optical element 20, however, and 10 times or less is thus preferable.

The length Eb of the mirror group 242 in the W2 direction may be the equal to the length Ea of the mirror group 241 in the W1 direction, smaller than the length of the mirror group 241 in the W1 direction, or greater than the length of the mirror group 241 in the W1 direction. The length of the retroreflective mirrors 25 in the W direction is 1 to 10 mm, for example, or 2 to 8 mm, for example. A difference in height of the retroreflective mirrors 25 in the V direction (difference in height between the ridge lines 301 and the valley lines 42) is 0.07 to 3.5 mm, for example, or 0.35 to 1.75 mm, for example.

As described with reference to FIGS. 1C and 1D, the reflective regions of the mirror groups 241 and 242 have a shape where recesses and protrusions are repeated in the X direction. Parts of the recesses are the valley lines 42, and parts of the protrusions are the ridge lines 301 (ridge lines 301a and 301b). The boundaries between the recesses and the protrusions can be set at a height one half the difference in height between the recesses and the protrusions in the V direction. In the example illustrated in FIG. 1B, the protrusions of the mirror group 241 and the protrusions of the mirror group 242 overlap, and the recesses of the mirror group 241 and the recesses of the mirror group 242 overlap, in the V1 and V2 directions. However, the protrusions of the mirror group 241 and the protrusions of the mirror group 242 can be offset in the X direction, and the recesses of the mirror group 241 and the recesses of the mirror group 242 can be offset in the X direction. As a result, the recesses of the mirror group 241 and the protrusions of the mirror group 242 may overlap, and the protrusions of the mirror group 241 and the recesses of the mirror group 242 may overlap, in the V1 and V2 directions.

### Second Exemplary Embodiment

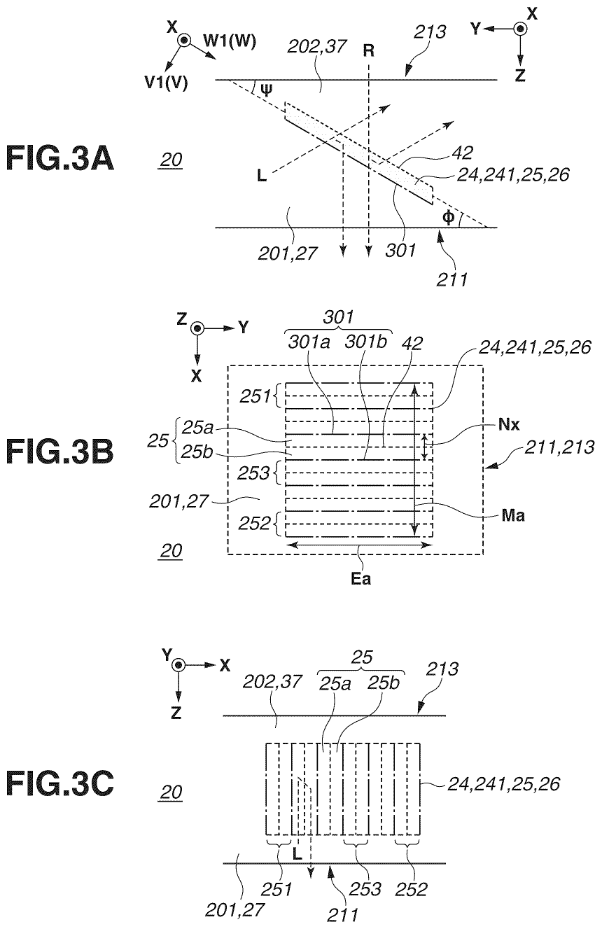

An optical element 20 according to a second exemplary embodiment will be described with reference to FIGS. 3A to 3C. FIG. 3A is a sectional view of the optical element 20 in a Y-Z plane. FIG. 3B is a plan view of the optical element 20 in an X-Z plane. FIG. 3C is a plan view of the optical element 20 in an X-Y plane.

The optical element 20 includes a mirror array 24, an optical surface 211 opposed to the mirror array 24, and an optical surface 213 opposed to the mirror array 24. The mirror array 24 is located between the optical surface 211 and the optical surface 213. The optical surface 211 is an optical surface having light transparency and/or light reflectivity. The optical surface 213 is an optical surface having light transparency and/or light reflectivity. Optical surfaces having light transparency can be referred to as transparent surfaces, and optical surfaces having light reflectivity as reflecting surfaces. The mirror array 24 includes a mirror group 241. The mirror group 241 is located between the optical surface 211 and the optical surface 213. As illustrated in FIG. 3B, the mirror group 241 includes a plurality of retroreflective mirrors 25 arranged in an X direction. While FIG. 3B illustrates three retroreflective mirrors 251, 252, and 253 out of six retroreflective mirrors 25 with the respective different reference numerals, the retroreflective mirrors 251, 252, and 253 are all examples of the retroreflective mirrors 25. The optical surfaces 211 and 213 are along the X direction and a Y direction intersecting the X direction. The Y direction is typically orthogonal to the X direction, but the Y direction may be oblique to the X direction. FIG. 3B illustrates the width Nx of the retroreflective mirrors 25 in the X direction. The width Nx of the retroreflective mirrors 25 in the X direction is similar to the width N (Na, Nb, or Nc) of the retroreflective mirrors 25 of the mirror group 241 in the X direction, described in the first exemplary embodiment.

As illustrated in FIG. 3A, the plurality of retroreflective mirrors 25 of the mirror group 241 extends obliquely to the optical surface 211, along a W1 direction intersecting the X and Y directions. In other words, the W1 direction in which the plurality of retroreflective mirrors 25 of the mirror group 241 extends is oblique to the optical surface 211. The W1 direction is typically orthogonal to the X direction, but the W1 direction may be oblique to the X direction. As illustrated in FIG. 3A, the plurality of retroreflective mirrors 25 of the mirror group 241 extends obliquely to the optical surface 213, along the W1 direction intersecting the X and Y directions. In other words, the W1 direction in which the plurality of retroreflective mirrors 25 of the mirror group 241 extends is oblique to the optical surface 213. The W1 direction is typically orthogonal to the X direction, but the W1 direction may be oblique to the X direction. In such a manner, the plurality of retroreflective mirrors 25 of the mirror group 241 extends along the W1 direction that intersects the X direction and is oblique to the optical surfaces 211 and 213.

In FIG. 3A, the W1 direction is illustrated in a dotted line. An angle ¢ formed between the W1 direction illustrated in the dotted line and the optical surface 211 is desirably greater than 15° (ϕ>15°), preferably greater than 20° (ϕ>20°), and desirably less than 60° (ϕ<60°), preferably less than 45° (ϕ<45°). An angle ψ formed between the W1 direction illustrated in the dotted line and the optical surface 213 is desirably greater than 15° (ψ>15°), preferably greater than 20° (ψ>20°), and desirably less than 60° (ψ<60°), preferably less than 45° (ψ<45°). The angle ¢ formed between the W1 direction illustrated in the dotted line and the optical surface 211 and the angle ψ formed between the W1 direction illustrated in the dotted line and the optical surface 213 may be the same or different. While the optical surfaces 211 and 213 can be parallel, the optical surfaces 211 and 213 may be non-parallel to each other.

A transparent portion 27 is located between the mirror array 24 and the optical surface 211. As a result, light propagates through the transparent portion 27 between the optical surface 211 and the mirror array 24. A transparent portion 37 is located between the mirror array 24 and the optical surface 213. As a result, light propagates through the transparent portion 37 between the optical surface 213 and the mirror array 24.

Since the mirror array 24 is located between the optical surfaces 211 and 213, both light propagation between the optical surface 211 and the mirror array 24 and light propagation between the optical surface 213 and the mirror array 24 can be used. Since the mirror array 24 is oblique to the optical surfaces 211 and 213, the light propagation between the optical surface 211 and the mirror array 24 and the light propagation between the optical surface 213 and the mirror array 24 can be implemented in various directions while using the retroreflective mirrors 25. This can achieve high optical performance. For example, as illustrated in FIG. 3A, a ray L incident on the mirror group 241 in the −Y direction obliquely relative to the optical surface 211 is reflected in the Z direction at the mirror group 241, incident on the optical surface 211, transmitted through the optical surface 211, and emitted out of the optical element 20. The traveling direction of the ray L may be reverse to the example of FIG. 3A, i.e., a ray incident on the optical surface 211 from outside the optical element 20 may be reflected at the mirror group 241. The ray L can be a ray propagated inside the optical element 20 (internal ray), for example. For example, as illustrated in FIG. 3A, a ray R incident on the mirror group 241 in the Z direction relative to the optical surface 213 can be reflected at the mirror group 241 to the −Y side in a direction oblique to the optical surface 213. If the retroreflective mirrors 25 have transparency, the ray R traveling from the optical surface 213 toward the mirror group 241 can be transmitted through the retroreflective mirrors 25 and reach the optical surface 211. For example, if the ray R is a ray incident on the optical surface 213 from outside the optical element 20 (external ray), the ray R can be taken out from the optical surface 211. Taking out both the rays R and L from the optical surface 211 enables superposition of the rays R and L. For example, if the external ray is natural light and the internal ray is artificial light such as image light, the natural light and the artificial light can be superposed. For example, XR techniques such as augmented reality (AR), virtual reality (VR), mixed reality (MR), and substitutional reality (SR) can be implemented by superposing an image of a virtual space (artificial light) on an image of the real space (natural light). Alternatively, the ray L can be used for display while the ray R is used for imaging. While the mirror group 241 of the mirror array 24 is described to be opposed to the optical surfaces 211 and 213, the mirror groups 242 and 243 described in the first exemplary embodiment may be similarly opposed to the optical surfaces 211 and 213.

### Third Exemplary Embodiment

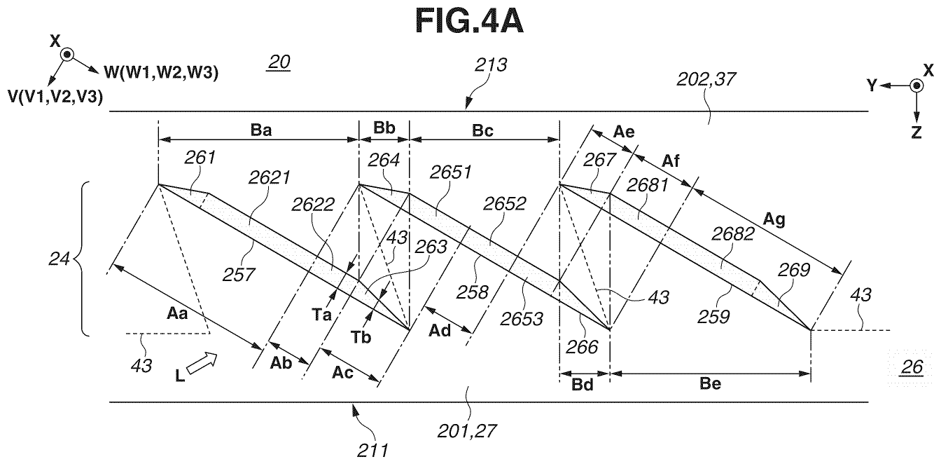

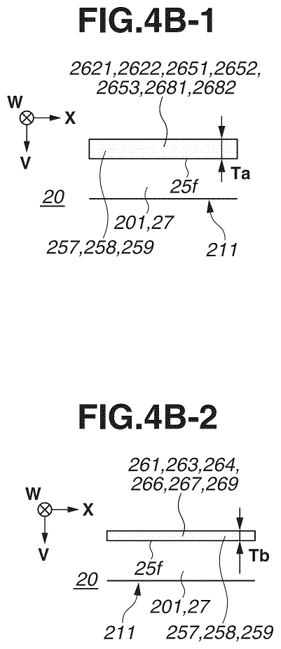

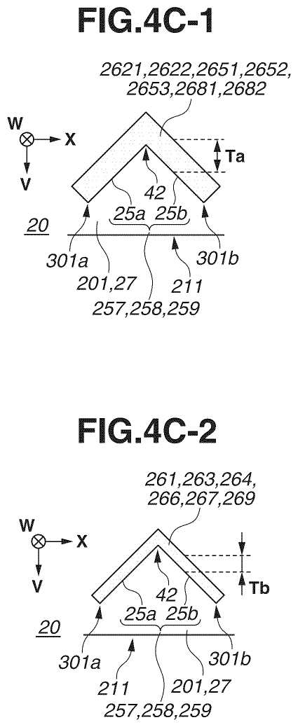

An optical element 20 according to a third exemplary embodiment will be described with reference to FIGS. 4A to 4C-2. FIG. 4A is a sectional view of the optical element 20 in a Y-Z plane (V-W plane). FIGS. 4B-1, 4B-2, 4C-1, and 4C-2 are sectional views of the optical element 20 in an X-V plane.

The optical element 20 includes a mirror array 24 and an optical surface 211 opposed to the mirror array 24. The optical surface 211 is an optical surface having light transparency and/or light reflectivity. An optical surface having light transparency can be referred to as a transparent surface, and an optical surface having light reflectivity as a reflecting surface. In the example of FIG. 4A, the optical element 20 further includes an optical surface 213 opposed to the mirror array 24, and the mirror array 24 is located between the optical surface 211 and the optical surface 213. However, the optical surface 213 may be omitted.

The mirror array 24 includes a transparent mirror 257, a transparent mirror 258, and a transparent mirror 259. The transparent mirror 257 extends along a W1 direction oblique to the optical surface 211. The transparent mirror 258 extends along a W2 direction oblique to the optical surface 211. The transparent mirror 259 extends along a W3 direction oblique to the optical surface 211. The W1, W2, and W3 directions may be parallel or non-parallel to each other.

The transparent mirrors 257, 258, and 259 of the mirror array 24 are constituted by a reflective body 26. A transparent portion 27 of a base 201 having the optical surface 211 supports the reflective body 26. A transparent portion 37 of a cover 202 having the optical surface 213 covers the reflective body 26. Connecting surfaces 43 illustrated in broken lines in FIG. 4A are connecting surfaces (interfaces) between the base 201 (transparent portion 27) and the cover 202 (transparent portion 37).

In the configuration with the plurality of transparent mirrors, part of light transmitted through a transparent mirror can be reflected at an adjacent transparent mirror and reach the optical surface 211 and eventually an observer positioned on the optical surface 211 side. For example, part of a ray L incident on the mirror array 24 is reflected at the transparent mirror 257 and reaches the observer while the rest of the light transmitted through the transparent mirror 257 is reflected at the transparent mirror 258 and reaches the observer. The light intensity in the overlapping regions where the adjacent transparent mirrors overlap as seen from the observer is thus higher than the light intensity in the non-overlapping regions where the adjacent transparent mirrors do not overlap as seen from the observer. This results in a distribution of light reaching the optical surface 211. In the overlapping regions where the transparent mirrors overlap as seen from the observer, the reflective body 26 is therefore formed to have lower reflectance than in the regions where the mirrors do not overlap. This can suppress local increases in the light intensity in the overlapping regions where the transparent mirrors overlap. The portions where the reflectance is reduced are not limited to both the front ends of the transparent mirrors on the optical surface 211 side and the rear ends on the optical surface 213 side in the W direction, and may be either the front ends or the rear ends.

The transparent mirror 257 includes high-reflection portions 2621 and 2622 and low-reflection portions 261 and 263. The low-reflection portions 261 and 263 of the transparent mirror 257 have a reflectance lower than that of the high-reflection portions 2621 and 2622 of the transparent mirror 257. The low-reflection portions 261 and 263 of the transparent mirror 257 have a transmittance higher than that of the high-reflection portions 2621 and 2622 of the transparent mirror 257. The high-reflection portions 2621 and 2622 are located between the low-reflection portions 261 and 263 in the W1 direction. The high-reflection portion 2621 is located between the low-reflection portion 261 and the high-reflection portion 2622 in the W1 direction. The high-reflection portion 2622 is located between the low-reflection portion 263 and the high-reflection portion 2621 in the W1 direction. The high-reflection portion 2621 is located in the midsection of the transparent mirror 257 in the W1 direction, and the low-reflection portions 261 and 263 are located at the ends of the transparent mirror 257 in the W1 direction. The high-reflection portion 2622 is located in between the midsection and an end of the transparent mirror 257 in the W1 direction.

The transparent mirror 258 includes high-reflection portions 2651, 2652, and 2653, and low-reflection portions 264 and 266. The low-reflection portions 264 and 266 of the transparent mirror 258 have a reflectance lower than that of the high-reflection portions 2651, 2652, and 2653 of the transparent mirror 258. The low-reflection portions 264 and 266 of the transparent mirror 258 have a transmittance higher than that of the high-reflection portions 2651, 2652, and 2653 of the transparent mirror 258. The high-reflection portions 2651, 2652, and 2653 are located between the low-reflection portions 264 and 266 in the W2 direction. The high-reflection portion 2651 is located between the low-reflection portion 264 and the high-reflection portion 2652 in the W2 direction. The high-reflection portion 2653 is located between the low-reflection portion 266 and the high-reflection portion 2652 in the W2 direction. The high-reflection portion 2652 is located in the midsection of the transparent mirror 258 in the W2 direction, and the low-reflection portions 264 and 266 are located at the ends of the transparent mirror 258 in the W2 direction. The high-reflection portions 2651 and 2653 are located in between the midsection and the ends of the transparent mirror 258 in the W2 direction.

The transparent mirror 259 includes high-reflection portions 2681 and 2682 and low-reflection portions 267 and 269. The low-reflection portions 267 and 269 of the transparent mirror 259 have a reflectance lower than that of the high-reflection portions 2681 and 2682 of the transparent mirror 259. The low-reflection portions 267 and 269 of the transparent mirror 259 have a transmittance higher than that of the high-reflection portions 2681 and 2682 of the transparent mirror 259. The high-reflection portions 2681 and 2682 are located between the low-reflection portions 267 and 269 in the W3 direction. The high-reflection portion 2681 is located between the low-reflection portion 267 and the high-reflection portion 2682 in the W3 direction. The high-reflection portion 2682 is located between the low-reflection portion 269 and the high-reflection portion 2681 in the W3 direction. The high-reflection portion 2682 is located in the midsection of the transparent mirror 259 in the W3 direction, and the low-reflection portions 267 and 269 are located at the ends of the transparent mirror 259 in the W3 direction. The high-reflection portion 2681 is located in between the midsection and an end of the transparent mirror 259 in the W3 direction.

The reflectance and transmittance of the high-reflection portions 2621, 2622, 2651, 2652, 2653, 2681, and 2682, and the low-reflection portions 261, 263, 264, 266, 267, and 269 can be adjusted by changing the structure of the reflective body 26 in those portions. Typically, the reflective body 26 can be configured in different thicknesses. For example, a typical thickness Ta of the high-reflection portions 2621, 2622, 2651, 2652, 2653, 2681, and 2682 typified by the high-reflection portion 2622 is larger than a typical thickness Tb of the low-reflection portions 261, 263, 264, 266, 267, and 269 typified by the low-reflection portion 263. Aside from the thicknesses Ta and Tb, the reflectance and transmittance can be adjusted by configuring the reflective body 26 with different refractive indexes or different layer configurations.

The transparent mirror 257 is located between the transparent mirror 258 and the optical surface 211 in a V1 direction intersecting the optical surface 211 and the W1 direction and/or a V2 direction intersecting the optical surface 211 and the W2 direction.

In the V1 direction and/or the V2 direction, the low-reflection portion 264 and the high-reflection portion 2622 overlap in an overlapping region Ab, and the low-reflection portion 263 and the high-reflection portion 2651 overlap in an overlapping region Ac. The low-reflection portion 261 and the high-reflection portion 2621 do not overlap the transparent mirror 258 in the V1 direction and/or the V2 direction, and are illustrated as a non-overlapping region Aa. The high-reflection portion 2652 does not overlap the transparent mirror 257 in the V1 direction and/or the V2 direction, and is illustrated as a non-overlapping region Ad.

The transparent mirror 258 is located between the transparent mirror 259 and the optical surface 211 in the V2 direction intersecting the optical surface 211 and the W2 direction and/or a V3 direction intersecting the optical surface 211 and the W3 direction.

In the V2 direction and/or the V3 direction, the low-reflection portion 267 and the high-reflection portion 2653 overlap in an overlapping region Ae, and the low-reflection portion 266 and the high-reflection portion 2681 overlap in an overlapping region Af. The low-reflection portion 269 and the high-reflection portion 2682 do not overlap the transparent mirror 257 in the V2 direction and/or the V3 direction, and are illustrated as a non-overlapping region Ag. The high-reflection portion 2652 does not overlap the transparent mirror 259 in the V2 direction and/or the V3 direction, and is illustrated as the non-overlapping region Ad.

In FIG. 4A, the overlapping regions Ab, Ac, Ae, and Af, and the non-overlapping regions Aa, Ad, and Ag in the V1, V2, and V3 directions are illustrated as divided by dot-dashed lines.

In the Z direction perpendicular to the optical surface 211, the low-reflection portions 263 and 264 overlap in an overlapping region Bb, and the low-reflection portions 266 and 267 overlap in an overlapping region Bd. The low-reflection portion 261 and the high-reflection portions 2621 and 2622 do not overlap the transparent mirror 258 in the Z direction, and are illustrated as a non-overlapping region Ba. The high-reflection portions 2651, 2652, and 2653 do not overlap the transparent mirror 257 or 259 in the Z direction, and are illustrated as a non-overlapping region Bc.

FIG. 4A illustrates a typical ray L of incident light on the mirror array 24. The ray L is reflected at the mirror array 24 and emitted from the mirror array 24, and travels toward the optical surface 211. For example, the angle that the incident direction of the ray L forms with the V direction and the angle that the emission direction of the ray L forms with the V direction are approximately equal. If the tilt angle of the W direction relative to the optical surface 211 is ϕ, the tilt angle of the incident direction of the ray L relative to the optical surface 211 is θ, and ϕ=θ, the angle that the incident direction of the ray L forms with the V direction and the angle that the emission direction of the ray L forms with the V direction are approximately equal to the tilt angles ϕ and θ. This makes the emission direction of the ray L perpendicular to the optical surface 211. That the low-reflection portions 263 and 264 overlap in the overlapping region Bb and the low-reflection portions 266 and 267 overlap in the overlapping region Bd in the Z direction perpendicular to the optical surface 211 is advantageous for reducing unevenness in the amount of reflected light when the mirror array 24 is observed in the Z direction.

If both the reflective portions of the transparent mirrors 257, 258, and 259 overlapping each other in the overlapping regions Ab, Ac, Ae, Af, Bb, and Bd are both high-reflection portions, the reflection by two overlapping high-reflection portions is higher than that by a single high-reflection portion in the non-overlapping regions Aa, Ad, Ag, Ba, Bc, and Be. Suppose, for example, that the transparent mirrors 257, 258, and 259 are half mirrors with a reflectance of 50% and a transmittance of 50% in their reflective portions, and incident light of intensity P is incident on two overlapping reflective portions. Of the two overlapping reflective portions, the first reflective portion reflects 50% reflected light (intensity P/2). Then, 50% transmitted light (intensity P/2) transmitted through the first reflective portion yields 50% reflected light (intensity P/4) at the second reflective portion, and 50% transmitted light thereof (intensity P/8) is further transmitted through the first reflective portion and emitted. Since the emitted light is the sum of the reflected light of intensity P/2 and the transmitted light of intensity P/8, the intensity of the emitted light is 5/8P. Since the emitted light from the reflective portions of the non-overlapping regions is only 50% reflected light (intensity P/2) from a single reflective portion, the overlapping regions yield emitted light 1.25 times that of the non-overlapping regions. The difference in the emitted light between the overlapping regions and the non-overlapping regions can therefore be reduced by reducing the reflectance of at least one of the two overlapping reflective portions.

In the overlapping regions Ab, Ac, Ae, Af, Bb, and Bd, at least either one of the overlapping portions of the transparent mirrors 257, 258, and 259 is thus configured as a low-reflection portion. This can suppress an extreme increase in the reflection at the overlapping regions Ab, Ac, Ae, Af, Bb, and Bd of the mirror array 24, and can reduce unevenness in the amount of light reflected by the mirror array 24.

FIGS. 4B-1 and 4B-2 illustrate a case where the transparent mirrors 257, 258, and 259 are non-retroreflective mirrors. FIG. 4B-1 is an X-V sectional view of the high-reflection portions 2621, 2622, 2651, 2652, 2653, 2681, and 2682. FIG. 4B-2 is an X-V sectional view of the low-reflection portions 261, 263, 264, 266, 267, and 269. The transparent mirrors 257, 258, and 259 that are non-retroreflective mirrors have a flat reflecting surface 25f. The thickness Tb of the low-reflection portions 261, 263, 264, 266, 267, and 269 is smaller than the thickness Ta of the high-reflection portions 2621, 2622, 2651, 2652, 2653, 2681, and 2682. The relationship between the thicknesses Ta and Tb controls the relative levels of the reflectance and transmittance.

FIGS. 4C-1 and 4C-2 illustrate a case where the transparent mirrors 257, 258, and 259 are retroreflective mirrors. FIG. 4C-1 is an X-V sectional view of the high-reflection portions 2621, 2622, 2651, 2652, 2653, 2681, and 2682. FIG. 4C-2 is an X-V sectional view of the low-reflection portions 261, 263, 264, 266, 267, and 269. The transparent mirrors 257, 258, and 259 that are retroreflective mirrors have a pair of reflecting surfaces 25a and 25b that are non-parallel to each other and opposed to each other in the above-described X direction. The ends of the reflecting surfaces 25a and 25b opposite to the optical surface 211 form a valley line 42. The retroreflectivity will be described in detail in a fourth exemplary embodiment. The thickness Tb of the low-reflection portions 261, 263, 264, 266, 267, and 269 is smaller than the thickness Ta of the high-reflection portions 2621, 2622, 2651, 2652, 2653, 2681, and 2682. The relationship between the thicknesses Ta and Tb controls the relative levels of the reflectance and transmittance.

The transmittance of the high-reflection portions 2621 and 2622 of the transparent mirror 257 may be the same as or different from that of the high-reflection portions 2651, 2652, and 2653 of the transparent mirror 258. In particular, if the reflectance of the high-reflection portions 2621 and 2622 of the transparent mirror 257 is lower than that of the high-reflection portions 2651, 2652, and 2653 of the transparent mirror 258, the light that is transmitted through the transparent mirror 257 and reaches the transparent mirror 258 can be increased. As a result, a difference between the amount of light reflected at the transparent mirror 257 and the amount of light reflected at the transparent mirror 258 can be reduced. For example, the thickness of the high-reflection portions 2621 and 2622 of the transparent mirror 257 can be made smaller than that of the high-reflection portions 2651, 2652, and 2653 of the transparent mirror 258.

The transmittance of the high-reflection portions 2651, 2652, and 2653 of the transparent mirror 258 may be the same as or different from that of the high-reflection portions 2681 and 2682 of the transparent mirror 259. In particular, if the reflectance of the high-reflection portions 2651, 2652, and 2653 of the transparent mirror 258 is lower than that of the high-reflection portions 2681 and 2682 of the transparent mirror 259, the light that is transmitted through the transparent mirror 258 and reaches the transparent mirror 259 can be increased. As a result, a difference between the amount of light reflected at the transparent mirror 258 and the amount of light reflected at the transparent mirror 259 can be reduced. For example, the thickness of the high-reflection portions 2651, 2652, and 2653 of the transparent mirror 258 can be made smaller than that of the high-reflection portions 2681 and 2682 of the transparent mirror 259.

The reflectance of the low-reflection portions 261 and 263 of the transparent mirror 257 may be the same as or different from that of the low-reflection portions 264 and 266 of the transparent mirror 258. In particular, if the reflectance of the low-reflection portions 261 and 263 of the transparent mirror 257 is lower than that of the low-reflection portions 264 and 266 of the transparent mirror 258, the light that is transmitted through the transparent mirror 257 and reaches the transparent mirror 258 can be increased. As a result, a difference between the amount of light reflected at the transparent mirror 257 and the amount of light reflected at the transparent mirror 258 can be reduced. For example, the thickness of the low-reflection portions 261 and 263 of the transparent mirror 257 can be made smaller than that of the low-reflection portions 264 and 266 of the transparent mirror 258.

The reflectance of the low-reflection portions 264 and 266 of the transparent mirror 258 may be the same as or different from that of the low-reflection portions 267 and 269 of the transparent mirror 259. In particular, if the reflectance of the low-reflection portions 264 and 266 of the transparent mirror 258 is lower than that of the low-reflection portions 267 and 269 of the transparent mirror 259, the light that is transmitted through the transparent mirror 258 and reaches the transparent mirror 259 can be increased. As a result, a difference between the amount of light reflected at the transparent mirror 258 and the amount of light reflected at the transparent mirror 259 can be reduced. For example, the thickness of the low-reflection portions 264 and 266 of the transparent mirror 258 can be made smaller than that of the low-reflection portions 267 and 269 of the transparent mirror 259.

In an exemplary embodiment where the first and/or second exemplary embodiment(s) is/are combined with the third exemplary embodiment, each of the plurality of retroreflective mirrors 25 of the mirror group 241 described in the first and second exemplary embodiments corresponds to the transparent mirror 257 described in the third exemplary embodiment. In an exemplary embodiment where the first exemplary embodiment is combined with the third exemplary embodiment, each of the plurality of retroreflective mirrors 25 of the mirror group 242 described in the first exemplary embodiment corresponds to the transparent mirror 258 described in the third exemplary embodiment.

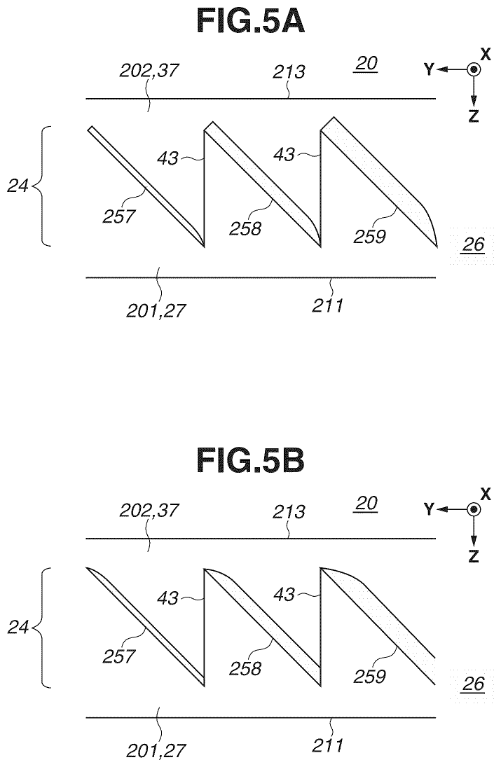

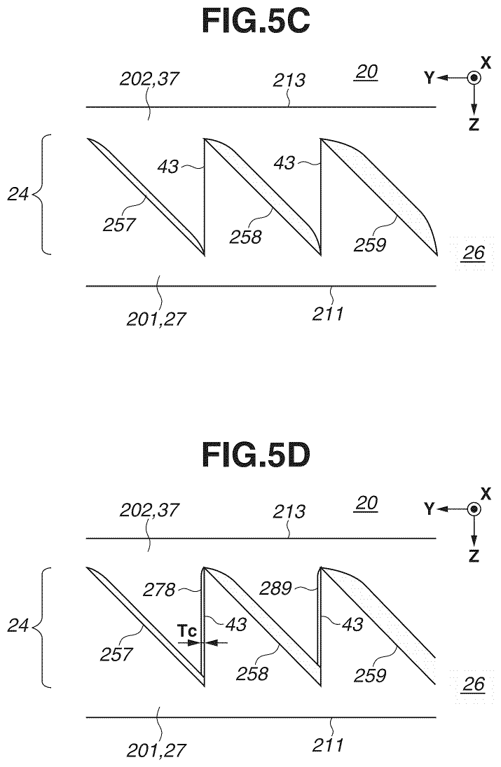

FIGS. 5A to 5D illustrate Y-Z sectional views of optical elements 20 like FIG. 4A. FIG. 5A illustrates an example where low-reflection portions are disposed at the front ends of the transparent mirrors 257, 258, and 259, and high-reflection portions are disposed at the rear ends. The reflectance of the high-reflection portions and the reflectance of the low-reflection portions increase in order of the transparent mirrors 257, 258, and 259. FIG. 5B illustrates an example where low-reflection portions are disposed at the rear ends of the transparent mirrors 257, 258, and 259, and high-reflection portions are disposed at the front ends. The reflectance of the high-reflection portions and the reflectance of the low-reflection portions increase in order of the transparent mirrors 257, 258, and 259. FIG. 5C illustrates an examples where low-reflection portions are disposed at the rear ends of the transparent mirrors 257, 258, and 259, and low-reflection portions are disposed at the front ends. The reflectance of the high-reflection portions and the reflectance of the low-reflection portions increase in order of the transparent mirrors 257, 258, and 259.

In the configuration illustrated in FIG. 4A, there is no reflective body 26 formed on the connecting surfaces 43. However, the reflective body 26 may be disposed on the connecting surfaces 43, along the connecting surfaces 43. As illustrated in FIG. 5D, the reflective body 26 on the connecting surfaces 43 also functions as transparent mirrors 278 and 289. The mirror array 24 can include such transparent mirrors 278 and 289. The transparent mirror 278 constituted by the reflective body 26 on the connecting surface 43 connecting the front end of the transparent mirror 257 and the rear end of the transparent mirror 258 connects the transparent mirrors 257 and 258. The transparent mirror 289 constituted by the reflective body 26 on the connecting surface 43 connecting the front end of the transparent mirror 258 and the rear end of the transparent mirror 259 connects the transparent mirrors 258 and 259. The reflective body 26 on the connecting surfaces 43 desirably has a reflectance lower than that of the foregoing high-reflection portions 2621, 2622, 2651, 2652, 2653, 2681, and 2682 so that light propagation between the transparent mirrors 257 and 258 in the Y direction will not be suppressed. Moreover, the reflectance of the reflective body 26 on the connecting surfaces 43 is desirably lower than that of the foregoing low-reflection portions 261, 263, 264, 266, 267, and 269. The reflective body 26 on the connecting surface 43 can be constituted by a dielectric material selected from silicon oxide, magnesium fluoride, magnesium oxide, aluminum oxide, tantalum oxide, titanium oxide, zirconium oxide, niobium oxide, and mixtures thereof. The reflective body 26 on the connecting surfaces 43 desirably has a thickness Tc smaller than the thickness Ta of the high-reflection portions and smaller than the thickness Tb of the low-reflection portions. Mirror characteristics such that the reflective body 26 located on a connecting surface 43 farther from the light incident portion has higher reflectance and lower transmittance are desirable. This makes differences in brightness less likely to occur in the displayed image depending on the angle of view.

While the example where the three transparent mirrors 257, 258, and 259 are juxtaposed in the Y direction has been described, the number of transparent mirrors may be two, four, or more as long as the plurality of transparent mirrors is arranged to overlap.

### Fourth Exemplary Embodiment

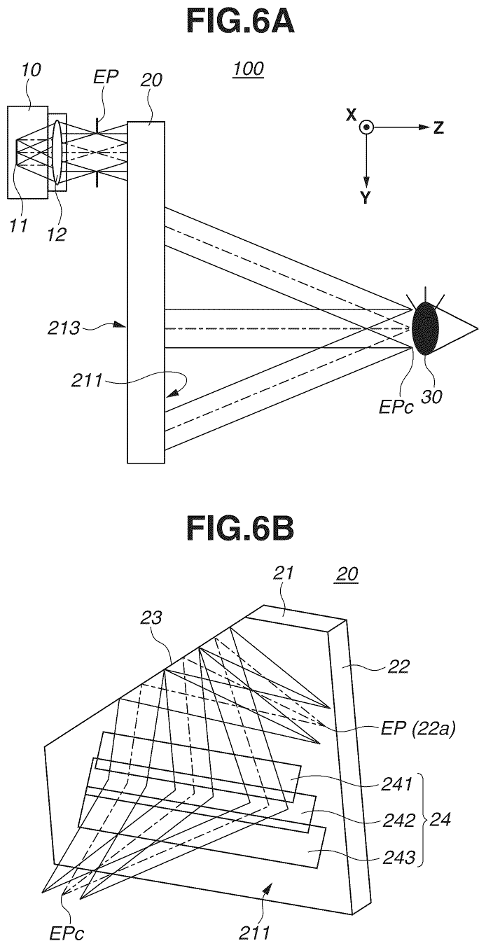

A display device 100 according to a fourth exemplary embodiment will be described with reference to FIGS. 6A and 6B. FIG. 6A is a schematic diagram of the display device 100. The display device 100 includes a projection unit 10 and an optical element 20. The optical elements 20 described in the first to third exemplary embodiments can be applied to the optical element 20 according to the fourth exemplary embodiment. For example, a description will be given by assuming the direction connecting an observer's left and right eyes as an X direction (arrangement direction), the direction connecting the observer's philtrum and glabella as a Y direction (juxtaposition direction), and a direction orthogonal to the X and Y directions (direction from an eye [pupil] 30 of the observer to the optical element 20) as a Z direction. The display device 100 can be used as AR (Augmented Reality) glasses.

The projection unit 10 includes a display element 11 such as an OLED (Organic Light Emitting Diode) and an LCD (Liquid Crystal Display), and a projection optical system 12. The projection optical system 12 includes a freeform surface prism, thereby achieving a wide acceptance angle and miniaturization. However, the present exemplary embodiment is not limited thereto, and the projection optical system 12 may include an ordinary optical system instead of the freeform surface prism. The optical element 20 is configured to form a pupil EPc conjugate with an exit pupil EP of the projection unit 10 (projection optical system 12) at the position of the observer's eye 30 in a one-dimensional direction (for example, horizontal direction [X direction]). In the present exemplary embodiment, the projection optical system 12 and the optical element 20 constitute an observation optical system that guides the light from the display element 11 to the observer's eye 30. In the thickness direction of the optical element, light beams entering the optical element 20 from the projection optical system 12 fill the entire thickness of the optical element 20. In the width direction of the optical element, the light beams having a beam width smaller than the width of the optical element travel through the optical element 20 with internal reflections. Of light beams exiting the optical element, ones in the width direction of the optical system are in charge of the arrangement direction (X direction), and ones in the thickness direction of the optical element the juxtaposition direction (Y direction).

In the present exemplary embodiment, the ratio of the angles of view of the display device 100 in the horizontal direction (X direction) and the vertical direction (Y direction) is 16:9. Since the pupil EPc conjugate with the exit pupil EP is desirably formed in the direction of the wider angle of view, the optical element 20 forms the pupil EPc conjugate with the exit pupil EP in the horizontal direction. However, the present exemplary embodiment is not limited thereto, and may be configured so that the pupil EPc conjugate with the exit pupil EP is formed in the vertical direction (Y direction) instead of the horizontal direction.

In the present exemplary embodiment, the state where the pupil EPC conjugate with the exit pupil EP of the projection unit 10 is formed on the observer's eye 30 will be referred to as “pupil conjugate”. The optical element 20 includes a mirror array 24 to be described below, and thereby forms the pupil EPc conjugate with the exit pupil EP of the projection unit 10 on the observer's eye 30 in a one-dimensional direction (horizontal direction or vertical direction). This can reduce useless light that does not enter the observer's eye 30, whereby the ratio of light reaching the observer's eye 30 to the light projected from the projection unit 10 (light use efficiency of the optical element 20) can be improved.

Note that the pupil conjugate configuration in the one-dimensional direction (horizontal direction) is desirably configured so that, in the non-pupil-conjugate direction of the mirror array 24 (vertical direction), light is incident on the mirror array 24 at a non-perpendicular angle and reflected in a different direction. The conjugate pupil EPc can thereby be located at a position different from the exit pupil EP.

As illustrated in FIG. 6B, the optical element 20 includes a light guide portion 21, an incident portion 22, and the mirror array 24. Image light from the projection unit 10 illustrated in FIG. 6A is incident on the incident portion 22. The light guide portion 21 has a function of guiding the image light from the incident portion 22 to the mirror array 24, and here includes a folding mirror 23. The mirror array 24 is a reflective unit that retroreflects the light from the projection optical system 12. In the present exemplary embodiment, the mirror array 24 includes a mirror group 241, a mirror group 242, and a mirror group 243. Each of a plurality of retroreflective mirrors 25 of the mirror group 241 corresponds to the transparent mirror 257 described in the third exemplary embodiment. Each of a plurality of retroreflective mirrors 25 of the mirror group 242 corresponds to the transparent mirror 258 described in the third exemplary embodiment. Each of a plurality of retroreflective mirrors 25 of the mirror group 243 corresponds to the transparent mirror 259 described in the third exemplary embodiment. The exit pupil EP of the projection optical system 12 is formed inside the optical element 20 (at the position of a root [front end] 22a of the incident portion 22). The light from the projection optical system 12 illustrated in FIG. 6A is reflected at the mirror array 24 in the optical element 20, whereby the pupil EPC conjugate with the exit pupil EP of the projection unit 10 can be formed outside the optical element 20 (at the position of the observer's eye 30) in the horizontal direction across the entire angle of view. Here, the optical surface 211 of the optical element 20 according to the present exemplary embodiment can be opposed to the eye 30. The light reflected at the mirror array 24 is transmitted through the optical surface 211 and can form an image (virtual image) outside the optical element 20.

Since the display device 100 according to the present exemplary embodiment uses the optical element 20, the display device 100 can be made low-profile. Moreover, the light use efficiency of the optical element 20 (the ratio of light reaching the observer's eye to the light projected from the display element) is high. This can achieve brightness that enables use in bright environments such as outdoors, and allow for a reduction in battery weight. The configuration of the optical element 20 can also reduce degradation and brightness distribution in the video image of the display element that reaches the observer's eye, and a high-quality display device can be provided. In particular, by placing the retroreflective mirrors 25 in the optical element 20 in a pupil conjugate manner, the light use efficiency can be improved to provide a bright display device 100. While the mirror array 24 constituted by arranging the retroreflective mirrors 25 (for example, right-angle mirrors) is a three-dimensional structure, the use of the optical element 20 described in the first exemplary embodiment enables favorable image display. As a result, a low-profile display device 100 with high light use efficiency and high image quality can be implemented.

### Fifth Exemplary Embodiment

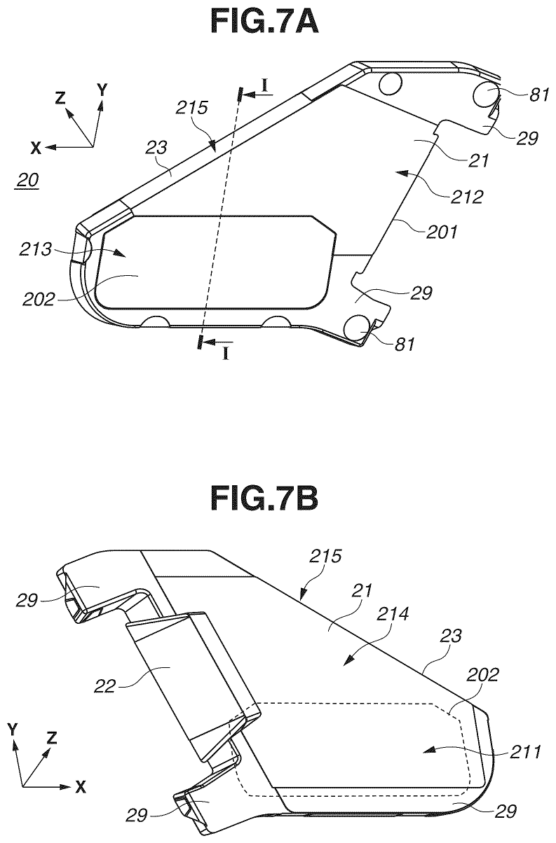

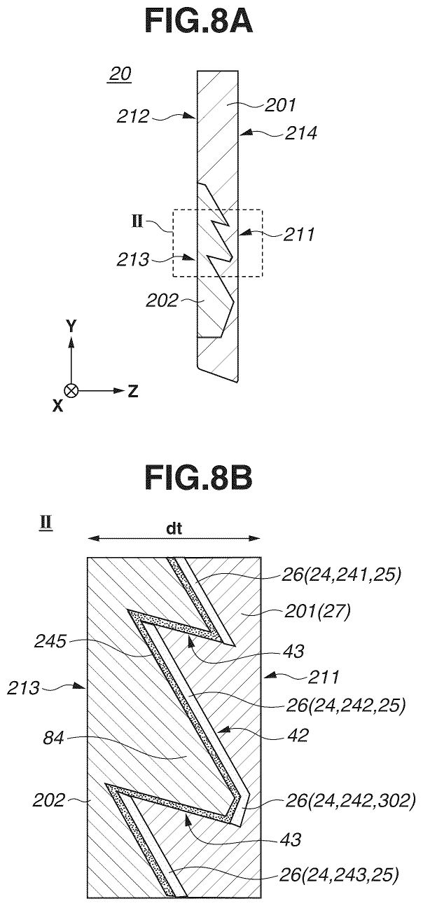

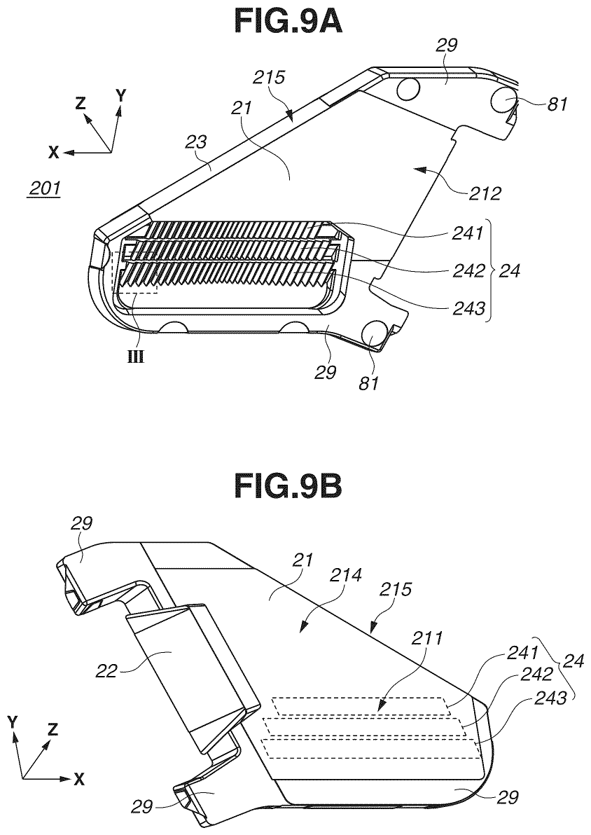

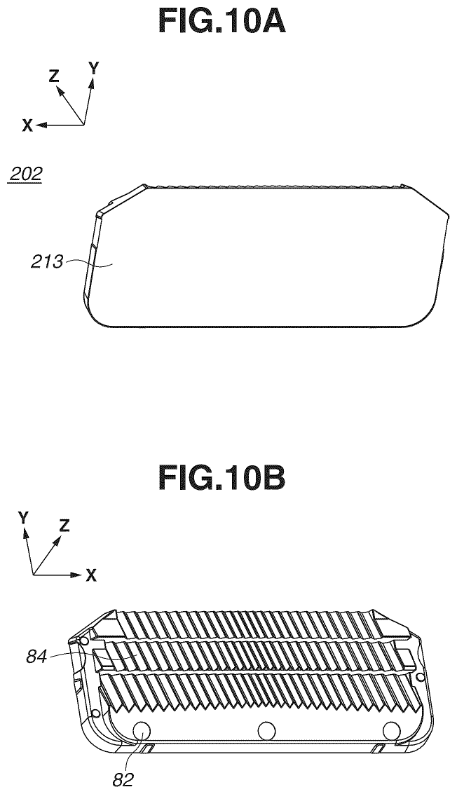

Next, a configuration of an optical element 20 according to a fifth exemplary embodiment will be described with reference to FIGS. 7A to 10B. The optical elements 20 described in the first to fourth exemplary embodiments can be applied to the optical element 20 according to the fifth exemplary embodiment. FIG. 7A is a perspective view of the optical element 20, seen mainly from the rear. FIG. 7B is a perspective view of the optical element 20, seen mainly from the front. FIG. 8A is a Y-Z sectional view of the optical element 20, taken along line I-I in FIG. 7A. FIG. 8B is an enlarged view of region II in FIG. 8A. FIG. 9A is a perspective view of a base 201 constituting the optical element 20, seen mainly from the rear. FIG. 9B is a perspective view of the base 201 constituting the optical element 20, seen mainly from the front. FIG. 10A is a perspective view of a cover 202 constituting the optical element 20, seen mainly from the rear. FIG. 10B is a perspective view of the cover 202 constituting the optical element 20, seen mainly from the front.

The optical element 20 mainly includes the base 201 and the cover 202. The base 201 has a front surface including an optical surface 211, a rear surface opposite to the front surface, and side surfaces connecting the front and rear surfaces. The base 201 includes a light guide portion 21, an incident portion 22, a mirror array 24, and peripheral portions 29. The mirror array 24 includes a mirror group 241, a mirror group 242, and a mirror group 243. However, the present exemplary embodiment is not limited thereto, and the number of mirror groups included in the mirror array 24 may be two, four, or more. As described in the first exemplary embodiment, reflecting surfaces 25a and 25b of the mirror array 24 are constituted by a reflective body 26. The reflecting surfaces 25a and 25b desirably have a surface roughness Ra (arithmetic average roughness) of 50 nm or less, preferably 25 nm or less. The surface roughness Ra may be 1 nm or more, or 5 nm or more.

The light guide portion 21 includes an optical surface 214 on the front surface including the optical surface 211 opposed to the mirror array 24. The light guide portion 21 includes an optical surface 212 on the rear surface opposite to the front surface where the optical surface 214 is located. The optical surfaces 214 and 212 can be reflecting surfaces of the light guide portion 21. The optical surfaces 214 and 212 can be reflecting surfaces that reflect light by total internal reflection within the light guide portion 21. In such a case, the optical surfaces 214 and 212 can also be transparent surfaces. Since the optical surfaces 214 and 212 are transparent surfaces, light incident on the optical surface 212 from outside can be emitted from the optical surface 214. The side surfaces of the base 201 include an optical surface 215 that constitutes a folding mirror 23. The reflection at the folding mirror 23 may be reflection by a reflective body located on the optical surface 215 or total internal reflection at the optical surface 215. The optical surfaces 211 to 215 desirably have a surface roughness Ra (arithmetic average roughness) of 50 nm or less, preferably 10 nm or less, more preferably 5 nm or less.

As illustrated in FIGS. 7A and 9A, the peripheral portions 29 located near the light guide portion 21 and the mirror array 24 have marks 81 from ejector pins of a mold used in molding the base 201, on the rear surface opposite to the front surface including the optical surface 211 opposed to the mirror array 24. Locating the marks 81 on the rear surface can widen the optical surfaces 211 and 214 on the front surface. The outer surfaces of the peripheral portions 29 may be rough surfaces rougher than the optical surfaces 211 to 215. The outer surfaces of the peripheral portions 29 may have a surface roughness Ra (arithmetic average roughness) of greater than 50 nm.

As illustrated in FIG. 8A, the cover 202 included in the optical element 20 is a component that covers the mirror array 24 from the side of the mirror array 24 opposite to the optical surface 211. As illustrated in FIG. 8B, the cover 202 includes an optical surface 213 and a filling portion 84. The optical surface 213 can be a transparent surface. The optical surface 213 is also opposed to the mirror array 24 like the optical surface 211. As illustrated in FIG. 8B, the distance dt between the optical surfaces 211 and 213 is 1 to 10 mm, for example, and preferably 2 to 6 mm. Disposing the mirror array 24 with the extending direction (W) of the retroreflective mirrors 25 oblique to the optical surfaces 211 and 213 and with the mirror groups 241, 242, and 243 juxtaposed in the Y direction is advantageous for reducing the distance dt. The distance from the optical surface 211 to the reflective body 26 can be 0.1 to 1.0 mm, for example, and preferably 0.25 to 0.75 mm. The distance from the optical surface 213 to the reflective body 26 can be 0.1 to 1.0 mm, for example, and preferably 0.25 to 0.75 mm.

The distance between the optical surfaces 212 and 214 is 1 to 10 mm, for example, and preferably 2 to 6 mm. The distance between the optical surfaces 212 and 214 can be 0.5 to 1.5 times, and preferably 0.75 to 1.25 times, the distance dt between the optical surfaces 211 and 213. The maximum thickness of the base 201 in the Z direction is 1.5 to 5.0 times, for example, and preferably 1.5 to 3.0 times, the distance between the optical surfaces 212 and 214. The thickness of the base 201 in the Z direction can typically be maximum at the incident portion 22. The minimum thickness of the base 201 in the Z direction is 0.01 to 0.5 times, for example, and preferably 0.05 to 0.5 times, the distance between the optical surfaces 212 and 214. The thickness of the base 201 in the Z direction can be minimum at a transparent portion 27, for example.

In the configuration of the optical element 20, the filling portion 84 is located to cover the mirror array 24, and the optical surface 213 is located next to the optical surface 212. To fit with the protrusion-and-recess pattern of the transparent portion 27, the filling portion 84 has a protrusion-and-recess pattern similar to the inverse of that of the transparent portion 27, and fills parts of the gaps of the mirror array 24. An adhesive member 245 is disposed between the reflective body 26 of the mirror array 24 and the cover 202. The cover 202 is fixed to the base 201 by this adhesive member 245. The adhesive member 245 fills the gap between the filling portion 84 and the mirror array 24. If the reflective body 26 has transparency, use of transparent material for the adhesive member 245 can suppress light loss between the base 201 and the cover 202. The adhesive member 245 has a thickness of 1 μm or more, for example, and 1 mm or less, for example, and 10 to 100 μm, for example. As illustrated in FIG. 10B, there are marks 82 from ejector pins of a mold used in molding the cover 202 near the filling portion 84 of the cover 202. Locating the marks 82 on the side opposite to the optical surface 213 can widen the optical surface 213.

The cover 202 (filling portion 84) can contain transparent material. The filling portion 84 containing transparent material constitutes at least a part of the transparent portion 37 illustrated in FIGS. 3A to 3C and 4A to 4C-2. The filling portion 84 can include portions located between the reflecting surfaces 25a and 25b in the X direction. If the reflective body 26 is a dielectric multilayer film, the refractive index of a high-refractive-index dielectric material included in the dielectric multilayer film of the reflective body 26 is desirably higher than that of the filling portion 84, but may be lower than that of the filling portion 84. The refractive index of a low-refractive-index dielectric material included in the dielectric multilayer film of the reflective body 26 is desirably lower than that of the filling portion 84, but may be higher than that of the filling portion 84. The transparent material constituting the filling portion 84 can be plastic or glass. Optical plastics such as acrylic resin, styrene resin, polyolefin resin, and polycarbonate can be used as the transparent material plastic. Such plastics have a refractive index of approximately 1.45 to 1.60. In particular, cycloolefin polymers are suitable as the plastic constituting the cover 202. The cycloolefin polymers are suitable for improving the performance of the optical element 20 due to their high transparency, light resistance, stability in refractive index and Abbe number, low birefringence, low specific gravity, high heat resistance, and precision moldability.

Light propagation between the optical surface 213 and the mirror array 24 is not essential, and the cover 202 (filling portion 84) may be formed of light-shielding material. If the reflective body 26 has transparency, the filling portion 84 desirably has transparency to propagate light transmitted through the reflective body 26. The filling portion 84 having transparency allows for light propagation from the transparent filling portion 84 to the light-transmissive transparent portion 27 via the transparent reflective body 26.

Aside from the material constituting the filling portion 84 (such as transparent material), the cover 202 may also contain coating material that covers the material constituting the filling portion 84. Various appropriate materials for protection (scratch prevention and stain prevention), anti-reflection, reflection enhancement, light shielding, and other purposes can be employed as the coating material. Transparent or light-shielding materials can be used as the coating material. The coating material may be inorganic or organic material. The coating material may constitute the optical surface 213 of the cover 202.

Light (image light) from a projection optical system 12 enters the incident portion 22 and travels with total internal reflections between the optical surfaces 214 and 212. The light from the projection optical system 12 changes its course at the optical surface 215 formed by the folding mirror 23, and travels toward the mirror array 24 with total internal reflections between the optical surfaces 214 and 212 again. The light from the projection optical system 12 then changes its course at the mirror array 24, exits from the optical surface 211, and reaches an observer's eye 30 on the optical surface 211 side. Reaching the observer's eye 30 via the mirror array 24, the light from the projection optical system 12 can form a pupil EPc conjugate with an exit pupil EP of a projection unit 10 outside the optical element 20 (at the position of the observer's eye 30) in the horizontal direction across the entire angle of view.

The mirror array 24 is located obliquely to the optical surfaces 211 and 213. More specifically, valley lines 42 formed by the reflecting surfaces 25a and 25b are oblique to the optical surfaces 211 and 213. In the present exemplary embodiment, the three mirror groups 241, 242, and 243 are arranged along the Y direction (juxtaposition direction). The angles that the three mirror groups 241, 242, and 243 form with the optical surface 211 are the same. There are connecting surfaces 43 connecting adjacent mirror groups between the mirror groups 241 and 242 and between the mirror groups 242 and 243. The contacting surfaces 43 are formed by the base 201 (transparent portion 27). The connecting surfaces 43 extend along the U direction described in the first exemplary embodiment. The angles formed between the connecting surfaces 43 and the optical surface 211 correspond to the angle β described in the first exemplary embodiment. One connecting surface 43 connects, in FIG. 1A, the end 2412 of the mirror group 241 on the mirror group 242 side and the end 2421 of the mirror group 242 on the mirror group 241 side orthogonally to the X direction. The connecting surfaces 43 can be covered with the reflective body 26, whereas the connecting surfaces 43 in this example are not covered with the reflective body 26, and the connecting surfaces 43 are in contact with the adhesive member 245. In other words, the adhesive member 245 contacts the base 201 at the connecting surfaces 43 of the base 201.

The observation optical systems according to the exemplary embodiments include an optical element (pupil-conjugate optical element) that forms a pupil conjugate with the exit pupil of the projection unit at the position of the observer's eye. This can achieve brightness that enables use in bright environments such as outdoors, and allow for a reduction in battery weight. According to the exemplary embodiments, a low-profile observation system and display device with high light use efficiency (ratio of light reaching the observer's eye to the light projected from the projection unit), and a method for manufacturing the observation optical system can thus be provided.

### Sixth Exemplary Embodiment

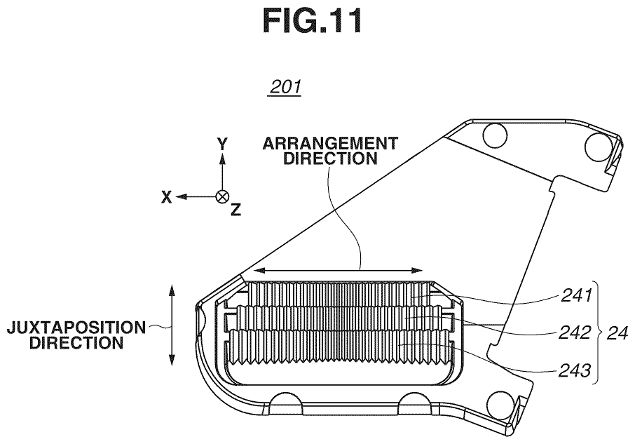

As a sixth exemplary embodiment, a configuration of a mirror array 24 will be described by using first to sixth examples. For an optical element 20 including the mirror array 24 according to the sixth exemplary embodiment, the base 201 described in the fifth exemplary embodiment can be used, for example. For the sake of convenience, as illustrated in FIG. 11, a case of application to the base 201 described in the fifth exemplary embodiment will thus be described. However, the optical element 20 to which the mirror array 24 according to the sixth exemplary embodiment can be applied is not limited to that described in the fifth exemplary embodiment.

### First Example

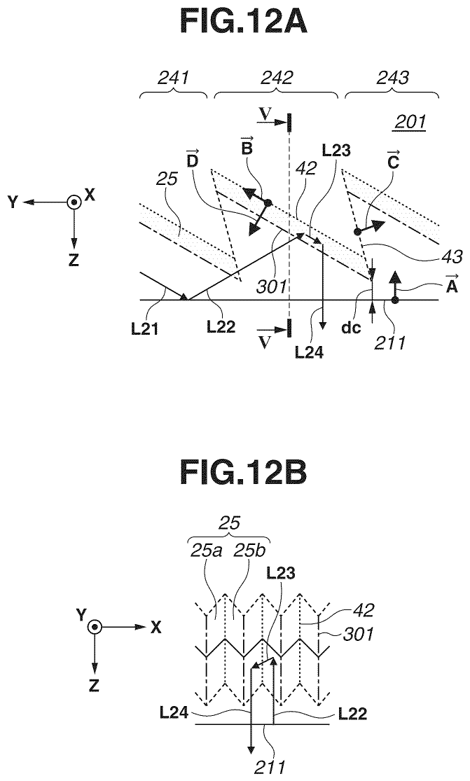

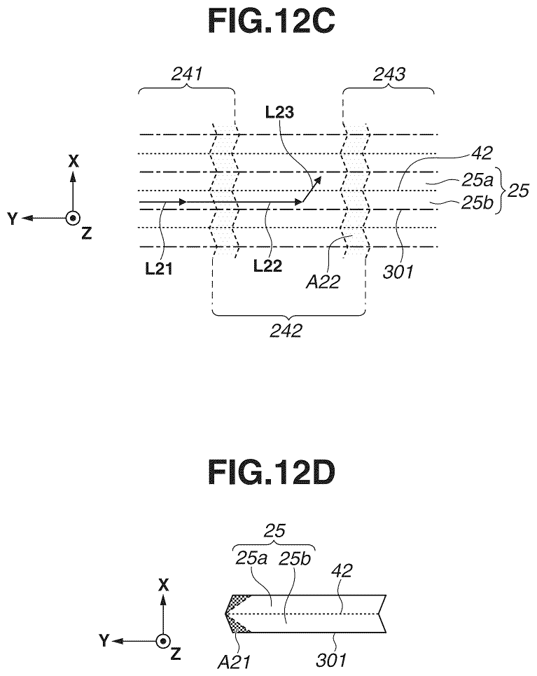

A first example of the sixth exemplary embodiment will be described with reference to FIGS. 12A to 12D. FIGS. 12A to 12D are front views of the base 201. FIG. 12A is a Y-Z sectional view of the base 201 along a juxtaposition direction. FIG. 12B is an X-Y sectional view of the base 201 along line V-V in FIG. 12A. FIG. 12C is a front view of FIG. 12A seen in a Z direction. FIG. 12D is a front view illustrating only one of the retroreflective mirrors 25 in FIG. 12C.

The mirror array 24 includes a plurality of retroreflective mirrors 25 each including a pair of reflecting surfaces 25a and 25b, arranged in an arrangement direction (X direction). The reflecting surface 25a and the reflecting surface 25b are located orthogonal to each other, and the retroreflective mirror 25 forms a right-angle mirror. Three mirror groups 241, 242, and 243 are arranged along a juxtaposition direction (Y direction). The mirror groups 241, 242, and 243 are located oblique to an optical surface 211. More specifically, valley lines 42 of the retroreflective mirrors 25 constituted by the reflecting surfaces 25a and 25b are oblique to the optical surface 211. The angles formed between the valley lines 42 of the three mirror groups 241, 242, and 243 and the optical surface 211 are the same. Ridge lines 301 formed between retroreflective mirrors 25 adjacent in the arrangement direction are also oblique to the optical surface 211. The angles formed between the ridge lines 301 of the three mirror groups 241, 242, and 243 and the operation surface 211 are the same, and the valley lines 42 and the ridge lines 301 are parallel. There are connecting surfaces 43 connecting adjacent mirror groups between the mirror groups 241 and 242 and between the mirror groups 242 and 243. In FIGS. 12A to 12D, the ridge lines 301 are illustrated in dot-dashed lines, and the valley lines 42 are illustrated in dotted lines.

Light from a projection optical system 12 enters an incident portion 22 and travels with total internal reflections between the optical surface 211 and an optical surface 212. The light from the projection optical system 12 changes its course at a folding mirror 23, and travels toward the mirror array 24 with total internal reflections between the optical surfaces 211 and 212 again. A ray L21 reaching the vicinity of the mirror array 24 is reflected at the optical surface 211. A ray L22 reflected at the optical surface 211 is retroreflected at the reflecting surfaces 25a and 25b like a ray L23, changes its course like a ray L24, and reaches an observer's eye 30 on the optical surface 211 side. Rays with different angles of view are each retroreflected at one of the retroreflective mirrors 25 of the mirror groups 241, 242, and 243, whereby an image is formed at the position of the observer's eye 30.

Since the retroreflective mirrors 25 have a three-dimensional structure, there are regions A21 where the retroreflective mirrors 25 are not capable of retroreflection. In other words, when seen from the observer's eye 30, the regions A21 are unable to display images and result in defective regions. The reason why the ray L24 is not emitted from the regions A21 is that there is no reflecting surface 25a or 25b to be paired with at the position where the ray L22 is to be reflected into the ray L23. The mirror groups are therefore located to overlap in the juxtaposition direction to cover the non-retroreflective regions A21. Specifically, the mirror groups 241 and 242, and the mirror groups 242 and 243, overlap in regions A22 as seen in the Z direction.

The mirror groups 241 and 242, and the mirror groups 242 and 243, also overlap as seen along a vector D that is perpendicular to a valley line 42 of a retroreflective mirror 25 and perpendicular to the arrangement direction.

By arranging the mirror groups in an overlapping manner to cover the non-retroreflective regions A21, a high quality image without defects can be formed at the position of the observer's eye 30. The connecting surfaces 43 are thus shaped with an undercut.

The mirror groups 241, 242, and 243 are situated obliquely at an angle of 30° to the optical surface 211. All the angles formed between the valley lines 42 of the three mirror groups 241, 242, and 243 and the optical surface 211 are equal and fall within the range of greater than 20° and less than 45°. All the angles formed between the ridge lines 301 of the three mirror groups 241, 242, and 243 and the optical surface 211 are equal and fall within the range of greater than 20° and less than 45°. The valley lines 42 and the ridge lines 301 are parallel. The connecting surfaces 43 are tilted within the range of greater than 0° and less than 45° relative to the optical surface 211, and shaped with an undercut shape. The retroreflective mirrors 25 are arranged at a pitch of 0.5 to 3 mm in the arrangement direction, and at a pitch of 3 to 10 mm in the juxtaposition direction. When seen in the Z direction, the mirror groups 241 and 242, and the mirror groups 242 and 243, overlap within the range of 0.1 to 3 mm in the juxtaposition direction.

The distances dc from the optical surface 211 to the ends of the ridge lines 301 of the mirror groups 241, 242, and 243 on the optical surface 211 side can be 0.1 to 1.0 mm. The distances dc from the optical surface 211 to the ends of the ridge lines 301 of the mirror groups 241, 242, and 243 on the optical surface 211 side may be the same (with a difference of 0.1 mm or less).

The direction parallel to the perpendicular to the optical surface 211 and pointing from the optical surface 211 to the retroreflective mirrors 25 will be represented by vector A. The direction parallel to the valley lines 42 of the retroreflective mirrors 25 and pointing away from the optical surface 211 will be represented by vector B. Here, the angle θ AB formed between vectors A and B desirably satisfies 45°<θ AB<70°. If the angle θ AB falls below 45°, the ray L22 reflected at the optical surface 211 and retroreflected at the retroreflective mirror 25 may not reach the observer's eye 30 on the optical surface 211 side like L24, and optically invalid rays can increase. On the other hand, if the angle θ AB exceeds 70°, rays may not be totally internally reflected at the optical surface 211, and t optically invalid rays can increase. Note that 45°<θ AB<70° can mean the same thing as 20°<α<45° described with reference to FIG. 1.

The direction parallel to the perpendicular to a connecting surface 43 and pointing away from the optical surface 211 will be represented by vector C. Here, the angle θ AC formed between vectors A and C desirably satisfies 45°<θ AC<90°. If the angle θ AC falls below 45°, the undercut of the connecting surface 43 is too steep to mold with high precision by resin molding. On the other hand, if the angle θ AC exceeds 90°, the undercut shape disappears, the regions A22 where the retroreflective mirror arrays overlap in the juxtaposition direction disappear, and the adjacent retroreflective mirrors 25 become no longer able to cover the non-retroreflective regions A21. Note that 45°<θ AC<90° can mean the same thing as 90°<β<135° described with reference to FIG. 1.

The angle θ BC formed between vectors B and C desirably satisfies 105°<θ BC<160°. If the angle θ BC falls below 105°, the front ends of the retroreflective mirrors 25 in the juxtaposition direction are too acute to mold with high precision by resin molding. On the other hand, if the angle θ BC exceeds 160°, the undercut shape disappears, the regions A22 where the retroreflective mirror arrays overlap in the juxtaposition direction disappear, and the adjacent retroreflective mirrors 25 become no longer able to cover the non-retroreflective regions A21. Note that 105°<θ BC<160° can mean the same thing as 15°<γ<70° described with reference to FIG. 1.

The ray L24 that is retroreflected at the retroreflective mirror 25 and travels to the observer's eye 30 may be oblique to the Z direction perpendicular to the optical surface 211 within the range of 0° or more and 50° or less, for example. The ray L24 may be oblique to the Y direction within the range of 0° or more and 30° or less. The obliquity varies depending on the position of the mirror array 24. An image with a wider field of view can be displayed the greater the obliquity.

### Second Example

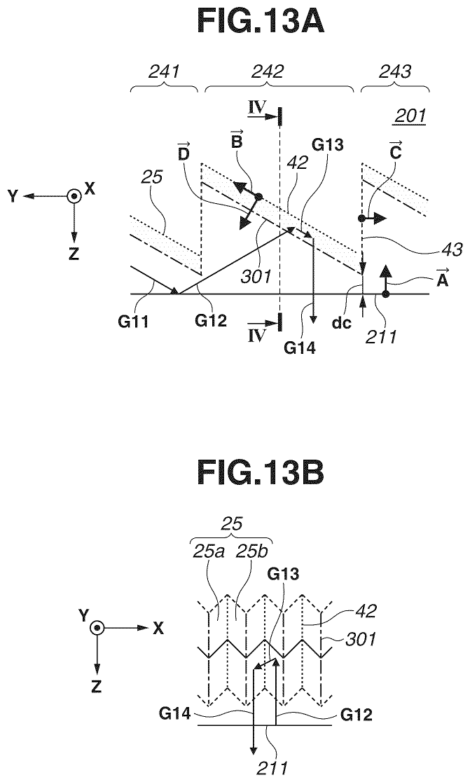

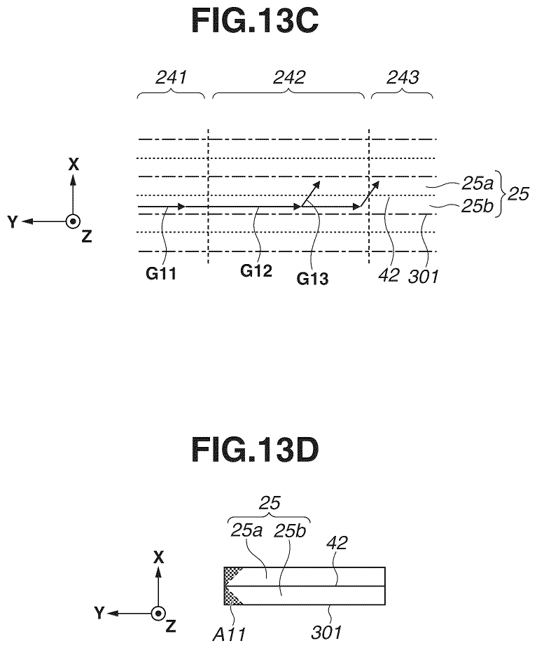

A second example of the sixth exemplary embodiment will be described with reference to FIGS. 13A to 13D. FIG. 13A is a YZ sectional view of the base 201 along the juxtaposition direction. FIG. 13B is an XY sectional view of the base 201 along line VI-VI in FIG. 13A. FIG. 13C is a front view of FIG. 13A seen in the Z direction. FIG. 13D is a front view illustrating only a pair of reflecting surfaces 25a and 25b in FIG. 13C. A description of items that can be similar to those of the first example is omitted, and differences from the first example will mainly be described.

Undercuts are difficult shapes to form in resin molded articles, and configurations without undercuts are typically suitable. As a comparative example for such situations, a case where the mirror groups do not overlap in the Z direction and the mirror groups 241 and 242, and the mirror groups 242 and 243, are located to adjoin as seen in the Z direction will be described. Here, the connecting surfaces 43 are perpendicular to the optical surface 211.

With this arrangement, regions A11 where the retroreflective mirrors 25 are not capable of retroreflection do not overlap the mirror group 241. When observed in the Z direction by the observer, defective regions where images are unable to be displayed can therefore be visible within the screen, depending on the size of the regions A11. To reduce the visibility of the regions A11, the incident angle to the mirror array 24 can be adjusted so that the light is reflected in a direction oblique to the Z direction.

### Third Example

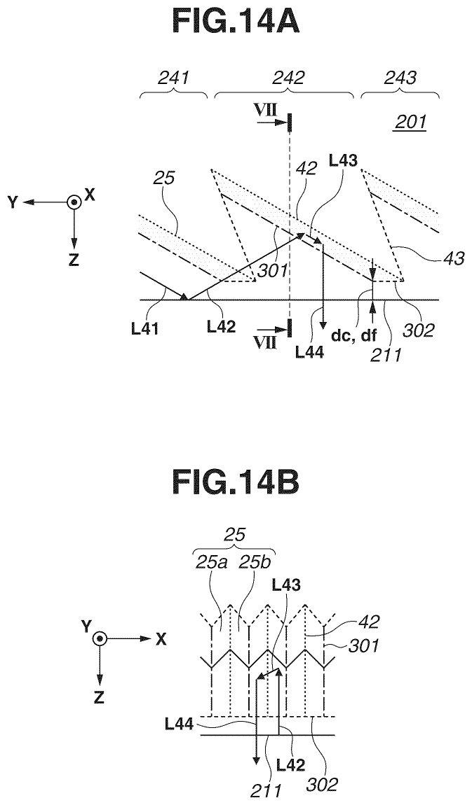

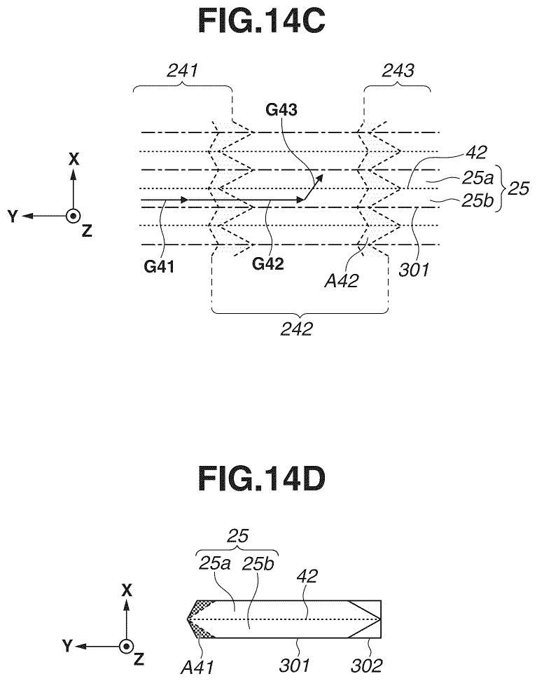

A third example will be described with reference to FIGS. 14A to 14D. FIG. 14A is an YZ sectional view of the base 201 along the juxtaposition direction. FIG. 14B is an XY sectional view of the base 201 along line VII-VII in FIG. 14A. FIG. 14C is a front view of FIG. 14A seen in the Z direction. FIG. 14D is a front view illustrating only one of the retroreflective mirrors 25 in FIG. 14C. A description of items that can be similar to those of the first example is omitted, and differences from the first example will mainly be described.

Compared to the first example, the ends of the retroreflective mirrors 25 in the juxtaposition direction are extended only toward the optical surface 211. The ends of the retroreflective mirrors 25 on the optical surface 211 side are cut so that the extended retroreflective mirrors 25 do not come extremely close to the optical surface 211, whereby non-opposed surfaces 302 are formed. The non-opposed surfaces 302 are located on the extensions of the ridge lines 301. The distance df from the optical surface 211 to the non-opposed surfaces 302 can be 0.1 to 1.0 mm. The non-opposed surfaces 302 can be surfaces along the X direction. The non-opposed surfaces 302 are therefore not opposed to the pair of reflecting surfaces 25a and 25b of at least one of the plurality of retroreflective mirrors 25 of the mirror group 242. While the non-opposed surfaces 302 here can be surfaces along the Y direction, the non-opposed surfaces 302 may be oblique to the Y direction. The non-opposed surfaces 302 overlap the mirror group 243 in the Z direction perpendicular to the optical surface 211.

Since the retroreflective mirrors 25 are extended, the areas of the retroreflective mirrors 25 increases. As a result, the same number of retroreflective mirrors 25 can display an image over a wider area, which is effective in expanding the viewing angle of the display device. Alternatively, an image can be displayed on the same area with fewer retroreflective mirrors 25, which is effective in improving the brightness of the display device.

Like the first example, the mirror groups are located to overlap in the juxtaposition direction to cover regions A41 where the retroreflective mirrors 25 are not capable of retroreflection. Specifically, the mirror groups 241 and 242, and the mirror groups 242 and 243, overlap in regions A42 when seen in the Z direction. By arranging the mirror groups to overlap so that the non-retroreflective regions A41 are covered, a high quality image without defects can be formed at the position of the observer's eye 30.

Moreover, extending the ends of the retroreflective mirrors 25 in the juxtaposition direction toward the optical surface 211 can increase the areas of the retroreflective mirrors 25 and facilitate machining during manufacturing by resin molding.

### Fourth Example

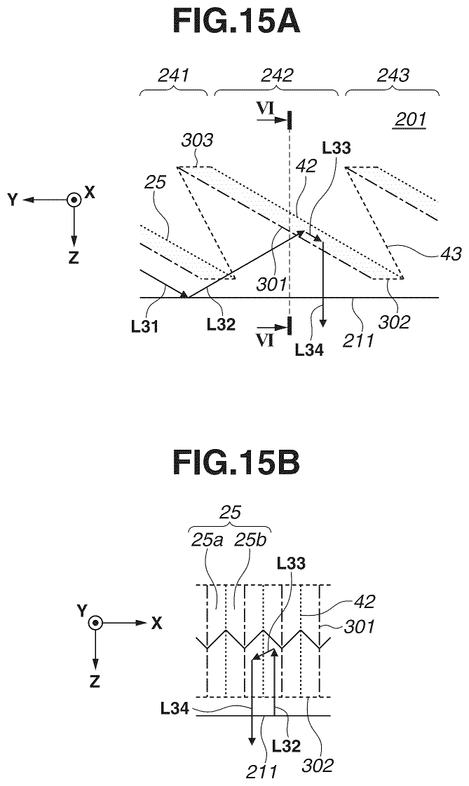

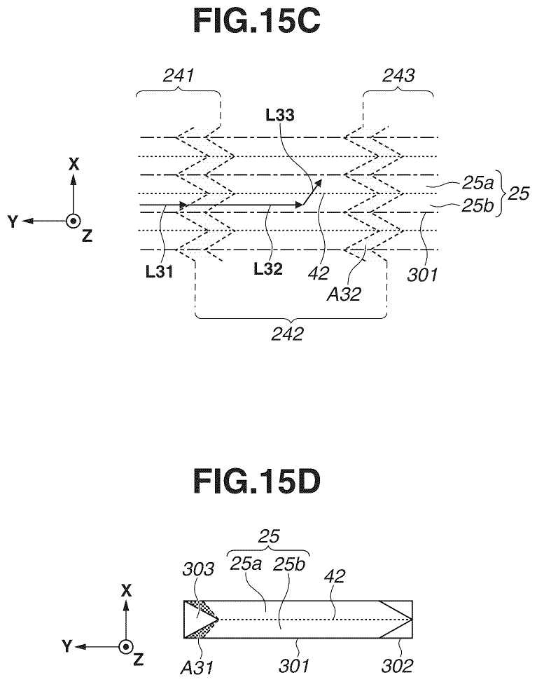

A fourth example of the sixth exemplary embodiment will be described with reference to FIGS. 15A to 15D. FIG. 15A is a YZ sectional view of the base 201. FIG. 15B is an XY sectional view of the base 201 along line VI-VI in FIG. 15A. FIG. 15C is a front view of FIG. 15A seen in the Z direction. FIG. 15D is a front view illustrating only one of the retroreflective mirrors 25 in FIG. 15C. A description of items that can be similar to those of the third example is omitted, and differences from the third example will mainly be described.

Compared to the third example, the ends of the retroreflective mirrors 25 in the extending direction are extended to the side opposite to the optical surface 211. The ends of the retroreflective mirrors 25 in the extending direction are cut so that the extended retroreflective mirrors 25 do not come extremely close to the optical surface 211 or a not-illustrated optical surface 213. Like the third example, non-opposed surfaces 302 are formed at the end of the mirror group 242 close to the optical surface 211 (end on the mirror group 243 side). Non-opposed surfaces 303 are also formed at the end of the mirror group 242 opposite to the optical surface 211 (end on the mirror group 241 side). The non-opposed surfaces 302 and 303 are located on the extensions of the ridge lines 301. The non-opposed surfaces 303 can be surfaces along the X direction. The non-opposed surfaces 303 are therefore not opposed to the pair of reflecting surfaces 25a and 25b of at least one of the plurality of retroreflective mirrors 25 of the mirror group 242. While the non-opposed surfaces 303 here can be surfaces along the Y direction, the non-opposed surfaces 303 may be oblique to the Y direction. The non-opposed surfaces 303 overlap the mirror group 241 in the Z direction perpendicular to the optical surface 211.

Since the retroreflective mirrors 25 are extended, the areas of the retroreflective mirrors 25 increases. As a result, the same number of retroreflective mirrors 25 can display an image over a wider area, which is effective in expanding the viewing angle of the display device. Alternatively, an image can be displayed on the same area with fewer retroreflective mirrors 25, which is effective in improving the brightness of the display device.

Like the first example, the mirror groups are located to overlap in the juxtaposition direction to cover regions A31 where the retroreflective mirrors 25 are not capable of retroreflection. Specifically, the mirror groups 241 and 242, and the mirror groups 242 and 243, overlap in regions A32 when seen in the Z direction. By arranging the mirror groups to overlap so that the non-retroreflective regions A31 are covered, a high quality image with fewer defects can be formed at the position of the observer's eye 30.

### Fifth Example

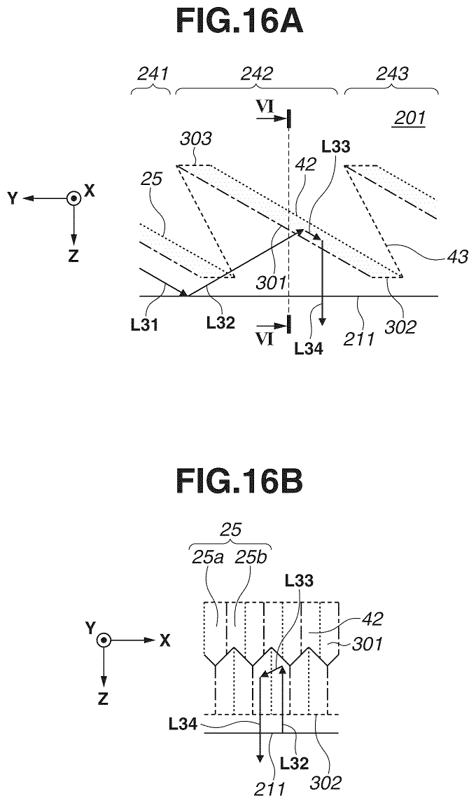

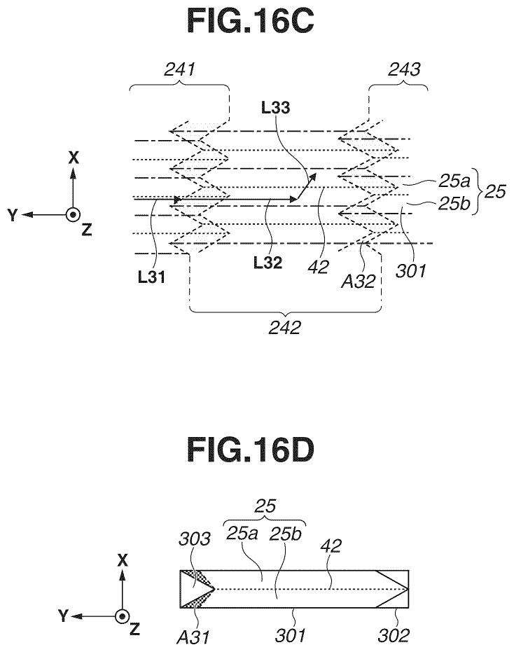

A fifth example of the sixth exemplary embodiment will be described with reference to FIGS. 16A to 16D. FIG. 16A is a YZ sectional view of the base 201. FIG. 16B is an XY sectional view of the base 201 along line VI-VI in FIG. 16A. FIG. 16C is a front view of FIG. 16A seen in the Z direction. FIG. 16D is a front view illustrating only one of the retroreflective mirrors 25 in FIG. 16C. A description of items that can be similar to those of the fourth example is omitted, and differences from the fourth example will mainly be described.

The mirror groups 241 and 242, and the mirror groups 242 and 243, are located in different phases. As a result, the recesses of the mirror group 241 and the protrusions of the mirror group 242 overlap, and the protrusions of the mirror group 241 and the recesses of the mirror group 242 overlap. The recesses of the mirror group 242 and the protrusions of the mirror group 243 overlap, and the protrusions of the mirror group 242 and the recesses of the mirror group 243 overlap. This can more efficiently cover the non-retroreflective regions A31.

Locating the non-retroreflective regions described in the first to fifth examples in the overlapping regions Ab, Ac, Ae, Af, Bb, and Bd described in the third exemplary embodiment is effective in reducing the visibility of the non-retroreflective regions. Locating the low-reflection portions described in the third exemplary embodiment in the non-retroreflective regions is also effective in reducing the visibility of the non-retroreflective regions.

### Sixth Example

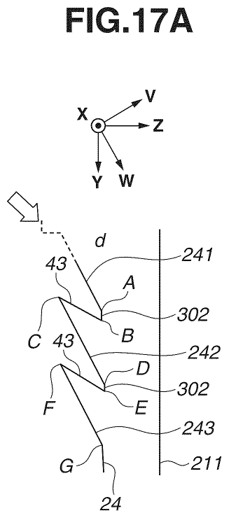

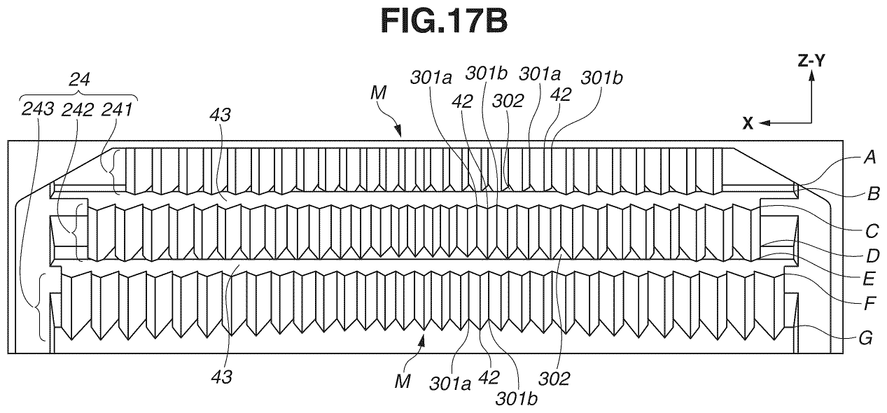

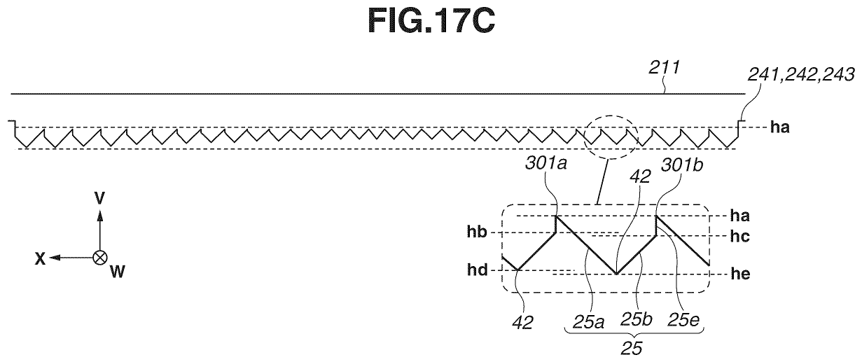

A sixth example of the sixth exemplary embodiment will be described with reference to FIGS. 17A to 17C. FIG. 17A is a Y-Z sectional view as well as a V-W sectional view of the base 201. FIG. 17B is a perspective view of the base 201 observed in the direction of the arrow in FIG. 17A, with the cover 202 detached. Points A to G in FIG. 17A correspond to boundaries A to G in FIG. 17B, respectively. FIG. 17C is an X-V sectional view perpendicular to a W direction.

The structure illustrated in FIGS. 17A and 17B may employ the third example of the sixth exemplary embodiment illustrated in FIGS. 14A to 14D, and a detailed description thereof will thus be omitted. In FIG. 17B, the mirror array 24 is viewed from the rear, and the peaks and valleys appear reversed from what has been described so far. Specifically, the portions that appear to be valleys recessed to the far side of the FIG. 17B are the ridge lines 301a and 301b when the mirror array 24 is seen from the optical surface 211. The portions that appear to be protruded toward the near side of the diagram are the valley lines 42 when the mirror array 24 is seen from the optical surface 211.

As illustrated in FIG. 17B, the width of the mirror group 242 in the X direction is greater than that of the mirror group 241 in the X direction. Moreover, the width of the mirror group 243 in the X direction is greater than that of the mirror group 242 in the X direction. This enables appropriate reflection in view of the spreading of light from the preceding stage (mirror group 241) toward the subsequent stage (mirror group 243).

The mirror group 241 includes 27 retroreflective mirrors 25. The mirror group 242 includes 29 retroreflective mirrors 25. The mirror group 243 includes 31 retroreflective mirrors 25.

As illustrated in FIG. 17B, the length of the mirror group 242 in the W direction is greater than that of the mirror group 241 in the W direction. Moreover, the length of the mirror group 243 in the W direction is greater than that of the mirror group 242 in the W direction. The length of the mirror group 242 in the Y direction is greater than that of the mirror group 241 in the Y direction. Moreover, the length of the mirror group 243 in the Y direction is greater than that of the mirror group 242 in the Y direction. This enables appropriate reflection in view of the spreading of light from the preceding stage (mirror group 241) toward the subsequent stage (mirror group 243). The lengths of the mirror groups 241, 242, and 243 in the W direction may be distributed within the range of 4 to 8 mm, for example.

As illustrated in FIGS. 17B and 17C, the mirror array 24 includes a plurality of retroreflective mirrors 25 each including a pair of reflecting surfaces 25a and 25b, arranged in the X direction. There is illustrated a central axis M of the mirror array 24 in the X direction that is the arrangement direction. The mirror array 24 can be symmetrical in the X direction, with the central axis M as the axis of symmetry. The reflecting surface 25a and the reflecting surface 25b are located orthogonal to each other, and the retroreflective mirror 25 forms a right-angle mirror. The reflecting surface 25a refers to the reflecting surface of the retroreflective mirror 25 on the central axis M side. The reflecting surface 25b refers to the reflecting surface of the retroreflective mirror 25 on the side opposite to the central axis M.

As illustrated in FIG. 17B, the recesses and protrusions of the mirror group 241 and the recesses and protrusions of the mirror group 242 are in different phases. Similarly, the recesses and protrusions of the mirror group 242 and the recesses and protrusions of the mirror group 243 are in different phases. More specifically, for example, a valley line 42 of the mirror group 241, a ridge line 301 of the mirror group 242, and a valley line 42 of the mirror group 243 are aligned on the central axis M. The recesses of the mirror group 241, the protrusions of the mirror group 242, and the recesses of the mirror group 243 are arranged in the Y direction. As a result, the recesses of the mirror group 241 and the protrusions of the mirror group 242 overlap, and the protrusions of the mirror group 242 and the recesses of the mirror group 243 overlap, in the V direction and the Z direction. The protrusions of the mirror group 241, the recesses of the mirror group 242, and the protrusions of the mirror group 243 are arranged in the Y direction. As a result, the protrusions of the mirror group 241 and the recesses of the mirror group 242 overlap, and the recesses of the mirror group 242 and the protrusions of the mirror group 243 overlap, in the V direction and the Z direction. This can increase the areas of the regions where the non-retroreflective regions at the preceding-stage-side ends of the subsequent-stage mirror groups in the Y direction overlap the subsequent-stage-side ends of the preceding-stage mirror groups in the Y direction.

Regarding the mirror group 241, as illustrated in FIGS. 17B and 17C, the widths of the plurality of retroreflective mirrors 25 constituting the mirror group 241 (distances between the ridge lines 301a and 301b) are nonuniform. Specifically, the retroreflective mirrors 25 have greater widths the farther from the central axis M the retroreflective mirrors 25 are in the X direction. The retroreflective mirrors 25 at both ends in the X direction thus have a width greater than those of the retroreflective mirrors 25 near the central axis M in the X direction. This enables appropriate reflection in view of the spreading of light from the central axis M toward both sides. The widths of the retroreflective mirrors 25 in the X direction may be distributed within the range of 0.5 to 1.5 mm, for example.

Regarding the mirror group 241, in the V-X sectional view illustrated in FIG. 17C, the distances of the valley lines 42 of the plurality of retroreflective mirrors 25 constituting the mirror group 241 from the optical surface 211 are nonuniform. Specifically, the distances of the valley lines 42 from the optical surface 211 are greater the farther the retroreflective mirrors 25 are from the central axis M in the X direction. For example, compared to the distance hd from the optical surface 211 to the valley lines 42 near the central axis M, the distance he from the optical surface 211 to the valley lines 42 far from the central axis M is large. The same applies to the mirror groups 242 and 243.

Regarding the mirror group 241, in the V-X sectional view illustrated in FIG. 17C, the distances ha of the ridge lines 301 of the plurality of retroreflective mirrors 25 constituting the mirror group 241 from the optical surface 211 can be the same (with a difference of 0.1 mm or less, for example). In FIG. 17C, the ridge lines 301 are illustrated to be arranged along the straight line (at the same distances ha). The same applies to the mirror groups 242 and 243. The distance ha can be 0.25 to 0.75 mm, for example.

As described above, the retroreflective mirrors 25 are configured so that the differences in height between the ridge lines 301 and the valley lines 42 increase outward from the central axis M. This enables appropriate retroreflection in view of the spreading of light. Note that the distances of the valley lines 42 from the optical surface 211 can be made uniform, and the distances of the ridge lines 301 from the optical surface 211 nonuniform. However, making the distances from the optical surface 211 to the ridge lines 301 closer to the optical surface 211 uniform is advantageous in terms of miniaturization and molding precision.

As illustrated in FIG. 17C, the retroreflective mirrors 25 include reflecting surfaces 25e that connect obliquely to the reflecting surfaces 25b. The reflecting surfaces 25e in this example are situated perpendicularly to the arrangement direction of the retroreflective mirrors 25 (X direction), or equivalently, along the V direction. The direction normal to the reflecting surfaces 25e is parallel to the arrangement direction of the retroreflective mirrors 25 (X direction). The reflecting surfaces 25a and the reflecting surfaces 25e are non-parallel to each other and opposed to each other in the X direction. The provision of such reflecting surfaces 25e can reduce gaps between light beams reflected at the mirror array 24.

Regarding the mirror group 241, in the V-X sectional view illustrated in FIG. 17C, the lengths of the reflecting surfaces 25e of the plurality of retroreflective mirrors 25 constituting the mirror group 241 in the V direction are nonuniform. Specifically, the farther a retroreflective mirror 25 is from the central axis M in the X direction, the greater the length of the reflecting surface 25e in the V direction. For example, the length ha to hc of the reflecting surfaces 25e farther from the central axis M in the V direction is greater than the length ha to hb of the reflecting surfaces 25e closer to the central axis M in the V direction. The same applies to the mirror groups 242 and 243. Making the lengths of the reflecting surfaces 25e in the V direction nonuniform can further reduce the gaps between the light beams reflected at the mirror array 24. This reduces variations occurring in the density of the display image, whereby a high quality image can be displayed.

### Seventh Exemplary Embodiment

As a seventh exemplary embodiment, a method for manufacturing an optical element 20 will be described with reference to FIGS. 7A to 10.

In a first formation step, a base 201 having a light guide portion 21, an incident portion 22, and a transparent portion 27 as illustrated in FIGS. 9A and 9B is formed by injection molding. During the injection molding, ejector pin marks 81 are formed as illustrated in FIG. 9A.

In a second formation step, a cover 202 including a filling portion 84 having a similar shape to that of the mirror array 24 as illustrated in FIGS. 10A and 10B is formed by injection molding. During the injection molding, ejector pin marks 82 are formed as illustrated in FIG. 10B. The material of the cover 202 is desirably a thermoplastic optical resin typified by PMMA, polycarbonate, or cycloolefin polymer (cyclic olefin resin).

In a third formation step, the reflective body 26 (see FIG. 8B) is formed on the transparent portion 27 of the base 201 formed in the first forming step, using an appropriate method like physical vapor deposition such as evaporation and sputtering, chemical vapor deposition, or liquid phase epitaxy such as plating. If the base 201 includes a plurality of retroreflective mirrors, the characteristics (transmittance characteristics and reflectance characteristics) of the reflective body 26 can be changed from one retroreflective mirror to another to adjust brightness depending on the angle of view of the display image (so that the brightness of the display image appears constant to the observer). For example, the reflectance of the reflective body 26 formed on subsequent-stage mirror groups can be made higher than that of the reflective body 26 on preceding-stage mirror groups. Moreover, the transmittance of the reflective body 26 formed on subsequent-stage mirror groups can be made lower than that of the reflective body 26 on preceding-stage mirror groups. For example, the reflectance of the reflective body 26 formed on the mirror group 243 can be made higher than that of the reflective body 26 on the mirror group 241, and the transmittance of the reflectance of the reflective body 26 on the mirror group 243 lower than that of the reflective body 26 on the mirror group 241.

In a fourth formation step, the optical element 20 is formed by bonding the base 201 formed in the third formation step and the cover formed in the second formation step, using an adhesive agent such as an ultraviolet curable resin. Here, the mirror array 24 and the filling portion 84 are bonded to form the optical element 20 as illustrated in FIGS. 7A and 7B. The ultraviolet curable resin becomes the foregoing adhesive member 245 (see FIG. 8B). According to the present exemplary embodiment, since the optical element 20 is manufactured by bonding the two molded articles (base 201 and cover 202), mass productivity and optical performance of the optical element 20 can be achieved in a compatible manner.

Note that the second formation step may be performed before the first formation step, or may be performed after the third formation step as long as it is before the fourth formation step. The second formation step may be performed simultaneously with the first formation step or the third formation step.

As another method for manufacturing the optical element 20, the third formation step may be replaced with formation of the reflective body 26 on the cover 202 formed in the second formation step. The cover 202 may be regarded as a component (base) that supports the reflective body 26, and the base 201 a component (cover) that covers the reflective body 26 (mirror array 24). If the cover 202 dimensionally smaller than the base 201 is used as the understructure for forming the reflective body 26, the cover 202 can be easily molded with high precision, and mass deposition can be performed at a time. The cover 202 having a small optical surface compared to the base 201 also facilitates the formation of the reflective body 26, since the region (optical surface) to be protected during the formation of the reflective body 26 so that the reflective body 26 will not be formed is small.

As another method for manufacturing the optical element 20, insert molding may be performed with either the base 201 or the cover 202 placed in a mold as an insert while the other of the base 201 and the cover 202 is injection molded in the mold. In such a case, the adhesive member 245 can be omitted, and either the first formation step or the second formation step can be integrated with the fourth formation step.

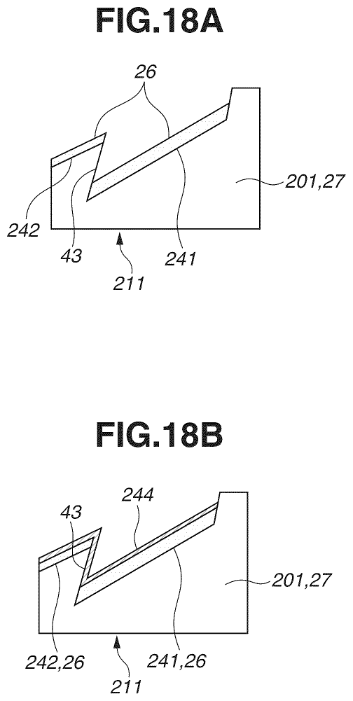

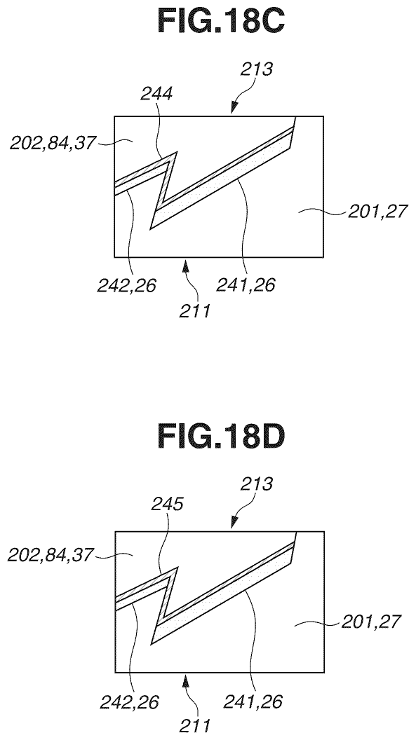

A specific example of the foregoing fourth formation step will be described with reference to FIGS. 18A to 18D.

FIG. 18A illustrates the state after the foregoing third formation step. The material of the base 201 is desirably a thermoplastic optical resin typified by PMMA, polycarbonate, or cycloolefin polymer (cyclic olefin resin). The reflective body 26 is formed on the transparent portion 27 of the base 201 by evaporation or sputtering. The material of the transparent portion 27 is desirably a thermoplastic optical resin typified by PMMA, polycarbonate, or cycloolefin polymer (cyclic olefin resin). The reflective body 26 can be selected between a total internal reflection mirror or a half mirror. The reflective body 26 is made of a material including silicon oxide, magnesium fluoride, magnesium oxide, aluminum oxide, tantalum oxide, titanium oxide, zirconium oxide, niobium oxide, or mixtures thereof, and the reflectance is controlled by the thickness and film structure.

FIG. 18B illustrates the step subsequent to FIG. 18A, where an adhesive agent 244 is applied to the reflective body 26. For the adhesive agent 244, an energy ray curable resin is used. For example, an ultraviolet curable resin is applied. Acrylic resin, epoxy resin, or mixtures thereof may be used for the ultraviolet curable resin. The adhesive agent 244 is also applied to the connecting surfaces 43.

FIG. 18C illustrates the step subsequent to FIG. 18B, where the cover 202 is placed on the adhesive agent 244. To reduce refraction of the transmitted light, the cover 202 is desirably molded of the same material (same substance) as that of the base 201. If the base 201 and the cover 202 are formed of different materials, a difference between the refractive index of the base 201 (transparent portion 27) and that of the cover 202 (transparent portion 37, filling portion 84) is desirably less than 0.01. If there is any void between the cover 202 and the reflective body 26 when the cover 202 and the reflective body 26 are assembled via the adhesive agent 244, the void may cause refraction or scattering of the reflected light and transmitted light, possibly affecting the optical performance. The space between the reflective body 26 and the cover 202 is therefore desirably filled with the adhesive agent 244. If an ultraviolet curable resin is used as the adhesive agent 244, the cover 202 and the reflective body 26 on the base 201 are sealed with the adhesive agent 244. The adhesive agent 244 is then irradiated and cured with ultraviolet rays from the optical surface 213 of the cover 202.

FIG. 18D illustrates the state where the adhesive agent 244 is cured into the adhesive member 245. If the adhesive member 245 is formed of a material different from those of the base 201 (transparent portion 27) and the cover 202 (transparent portion 37) and there is a large difference in the refractive index between the transparent portions 27 and 37, rays transmitted through the transparent portion 37, the transparent reflective body 26, and the adhesive member 245 will undergo significant refraction. Therefore, while the thickness of the adhesive member 245 may be 1 μm or more, it desirably is 1 mm or less. For example, in view of factors such as application workability of the adhesive agent 244, the thickness of the adhesive member 245 can be set to 10 to 100 μm, e.g., 50 μm. A difference in the refractive index between the adhesive member 245 and the base 201 (transparent portion 27) is desirably less than 0.25, preferably 0.01 or less. A difference in the refractive index between the adhesive member 245 and the cover 202 (transparent portion 37) is desirably less than 0.25, preferably 0.01 or less. This can reduce the effect of refraction due to the sealing of the adhesive member 245.

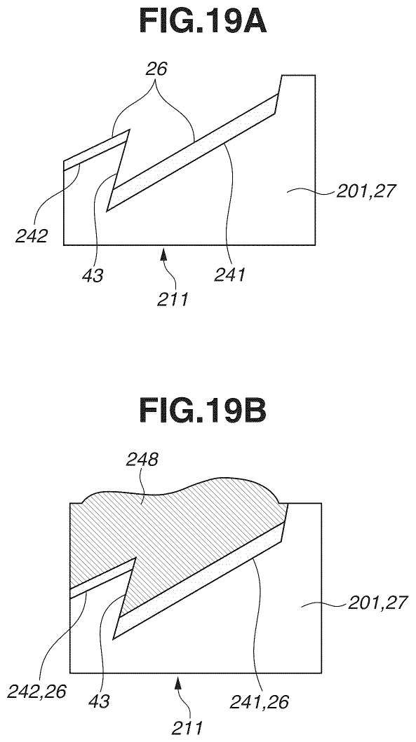

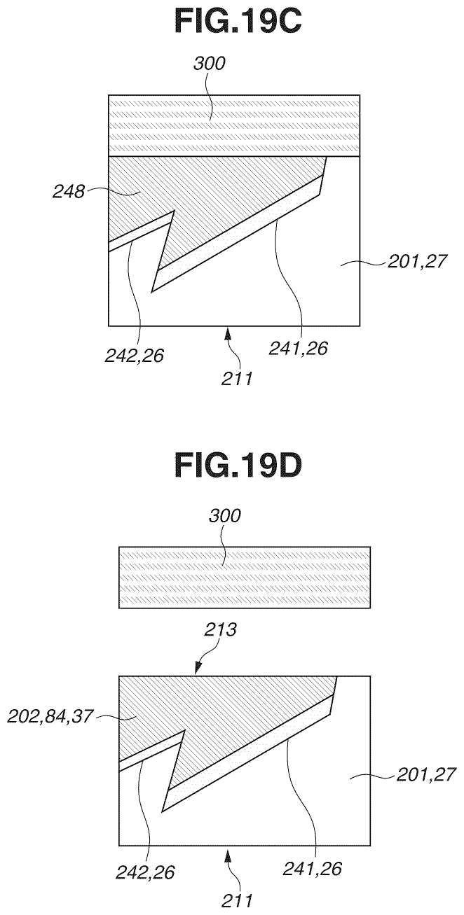

As another manufacturing method, FIGS. 19A to 19D illustrate a configuration of the optical element 20 where the cover 202 is formed without using the adhesive member 245.

In the step illustrated in FIG. 19A, like FIG. 18A, the reflective body 26 is formed on the transparent portion 27 of the base 201 by evaporation or sputtering.

In the step illustrated in FIG. 19B, a fluid resin 248 is disposed on the reflective body 26 by application or other methods. The fluid resin 248 is typically an uncured photocurable resin, but may be a molten thermoplastic resin or uncured thermosetting resin.

In the step illustrated in FIG. 19C, to form the optical surface 213 at the surface of the resin 248, a die 300 fabricated to the surface shape of the optical surface 213 is brought into contact with the resin 248, whereby the surface shape of the die 300 is transferred to the resin 248.

In the step illustrated in FIG. 19D, the resin 248 is irradiated with energy rays (light) to cure the resin 248. If the die 300 here is an opaque one, the energy rays for curing is transmitted through the transparent portion 27 from the optical surface 211 side to irradiate the resin 248. The resin 248 is cured into the cover 202 having the filling portion 84, the transparent portion 37, and the optical surface 213. FIG. 19D illustrates a state where the die 300 is released after the curing of the resin 248.

In the steps of applying and curing the resin 248, the process may be performed in multiple stages, taking into consideration dimensional changes due to cure shrinkage and the development of internal stress.

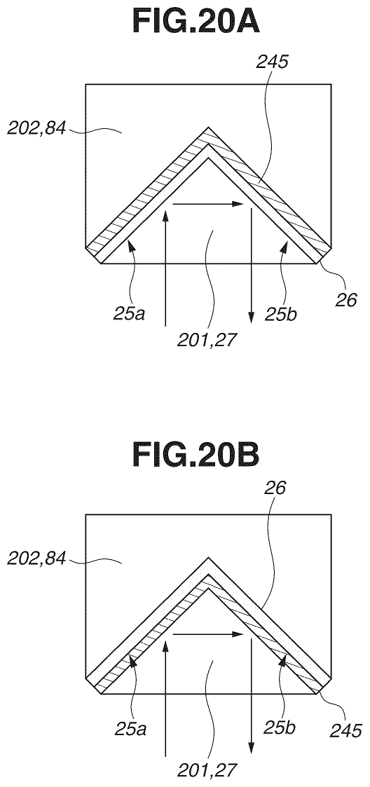

FIGS. 20A and 20B are diagrams illustrating a ray that propagates inside the transparent portion 27 of the base 201 via the reflecting surfaces 25a and 25b of the retroreflective mirror 25. When the ray transmitted through the inside of the transparent portion 27 reaches the reflecting surface 25a of the base 201, the ray is reflected at the reflective body 26 on the surface of the transparent portion 27. The reflected light is also reflected at the reflecting surface 25b and emitted toward the not-illustrated optical surface 211. Since the light reflected once at each of the reflecting surfaces 25a and 25b arrives, the reflecting surfaces 25a and 25b need to be formed with precise squareness.

In the example illustrated in FIG. 20A, where the inner surface of the transparent portion 27 is configured to be reflective, the ray can be reflected without being affected by the thickness distributions occurring in the reflective body 26 and the adhesive member 245 or the refractive indexes thereof. Since the retroreflective mirrors 25 can be formed into the right-angled retroreflective shape using the mold, the squareness is highly precise and manufacturing variations are small. An optical element 20 with high optical performance can thus be obtained by employing the configuration according to the present exemplary embodiment.

By contrast, in the example illustrated in FIG. 20B, the reflective body 26 is formed on the filling portion 84, and bonded to the base 201 with the adhesive member 245. The surfaces of the reflecting surfaces 25a and 25b are defined not by the mold but by the surface of the reflective body 26 during film deposition. The deposited surface of the reflective body 26 may have small asperities, and the presence of the asperities on the reflecting surfaces 25a and 25b can lower the precision of reflection at the reflecting surfaces 25a and 25b compared to the case of FIG. 20A. In addition, there can be effects from the thickness of the adhesive member 245 and the assembly error of the base 201 and the cover 202 (and the reflective body 26).

To obtain a high-precision optical element 20, the structure and manufacturing method of FIG. 20A can be said to be preferable compared to those of FIG. 20B.

### Eighth Exemplary Embodiment

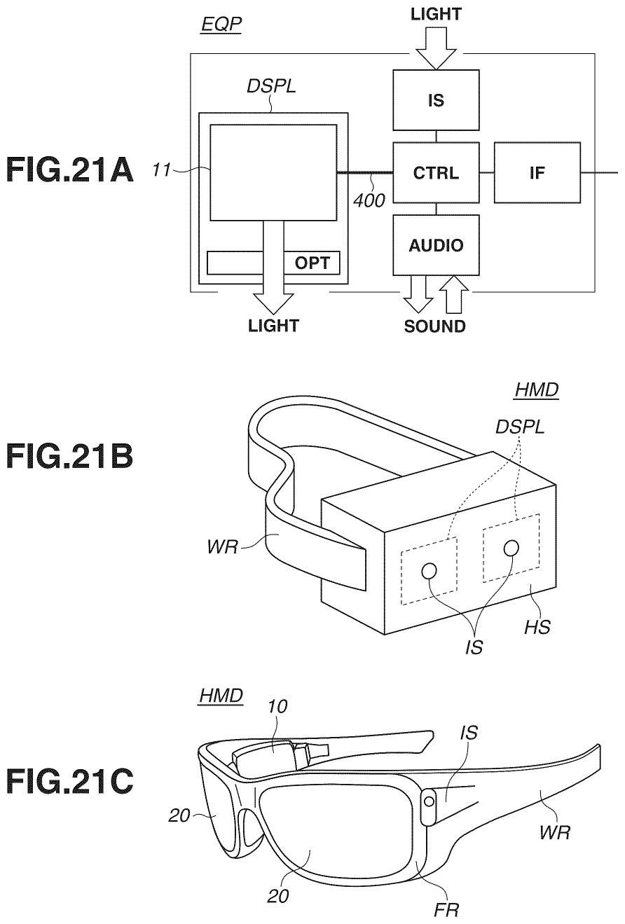

As an eighth exemplary embodiment, equipment EQP including an optical element 20 will be described with reference to FIGS. 21A and 21B. The present exemplary embodiment deals with an example of equipment EQP including a display device DSPL as illustrated in FIG. 21A. The display device 100 according to the foregoing fourth exemplary embodiment can be applied to the display device DSPL. An optical system OPT included in the display device DSPL is an observation optical system for guiding light from a display element 11 to an observer's eye 30, and can include the projection optical system 12 described in the fourth exemplary embodiment aside from the optical element 20. The optical elements 20 described in the first to seventh exemplary embodiments can be applied to the present exemplary embodiment.

The optical system of the equipment EQP includes the projection optical system 12 that projects the light from the display element 11, and the optical element 20 that guides the light from the projection optical system 12 to the observer's eye. The optical element 20 can be configured to form a pupil conjugate with the exit pupil of the projection optical system 12 outside the optical element 20.

The equipment EQP can include at least one of a control device CTRL, a communication device IF, an imaging device IS, and an audio device AUDIO. The control device CTRL controls the display device DSPL. The control device CTRL can be a DSP or ASIC. The control device CTRL can include a processing unit, and the processing unit may be configured to perform artificial intelligence-based computing. The control device CTRL can also include a power supply unit, and may supply power to the display device DSPL and the imaging device IS. The communication device IF communicates (transmits/receives) signals including information to be displayed on a display area of the display element 11. The communication device IF has a wireless communication function and/or a wired communication function. The communication device IF may have only a reception function without a transmission function. The optical system OPT projects the image displayed on the display element 11 upon a screen or the retina. The optical system OPT can include a lens, a prism, and/or a mirror. The equipment EQP including the display device DSPL may include the imaging device IS. The equipment EQP can display images captured by the imaging device IS on the display device DSPL. The equipment EQP including the imaging device IS may be a camera or an information device with a camera.

The imaging device IS captures images. The images captured by the imaging device IS can be displayed on the display area of the display element 11. The imaging device IS can be a CMOS image sensor that photoelectrically converts light taken in from outside the equipment EQP. The audio device AUDIO can include a microphone that inputs sound from outside the equipment EQP and/or speakers that output sound. In particular, the imaging device IS and the audio device AUDIO can be omitted as appropriate depending on the specifications of the equipment EQP and the user's demand.

The equipment EQP is suitable for electronic devices such as information terminals with display functions (for example, smartphones and wearable terminals) and cameras (for examples, interchangeable lens cameras, compact cameras, video cameras, and surveillance cameras). The equipment EQP can be transportation equipment such as vehicles, ships, and aircrafts. Alternatively, the equipment EQP may be ophthalmic or other medical devices, measuring instruments such as range sensors, or office equipment such as copying machines.

The equipment EQP including the display device DSPL may be a mobile device such as a smartphone, a mobile PC, and a tablet. The equipment EQP including the display device DSPL may be a wearable device. The wearable device is a type of mobile device. The optical element 20 can be applied to wearable devices such as smartglasses, an HMD (Head Mounted Display), and a goggle display.

FIG. 21B illustrates an example of a head mounted display HMD as an example of the equipment EQP. The head mounted display HMD includes a mounting means WR for using the equipment EQP as a head mounted display. The mounting means WR is a band, a strap, or the like. The optical element 20 can be mounted on the user's head using the mounting means WR. The head mounted display HMD includes a plurality of display devices DSPL so that the user can observe images with both eyes. Moreover, the head mounted display HMD includes a plurality of imaging devices IS so that distance information can be obtained. The display devices DSPL and the imaging devices IS are accommodated in a housing HS. The microphone of the audio device AUDIO is located near the user's mouth, whereby sound emitted from the user's mouth can be input to the microphone. The speakers of the audio device AUDIO are located near the user's ears, so that the speakers can output sound to the user's ears.

FIG. 21C illustrates a schematic diagram for describing a head mounted display HMD of glasses type as an example of the equipment EQP that is a wearable device. The head mounted display HMD is a grasses-type device and includes a glasses-type frame FR. For example, the head mounted display HMD can include the projection unit 10 described in the fourth exemplary embodiment, and optical elements 20 having incident portions on which light from the projection unit 10 is incident. The frame FR includes rims and a bridge to hold the optical elements 20, temples to be hooked over the ears, and nose pads. The optical elements 20 can be mounted on the user's head using the mounting means WR such as the temples and nose pads.

An imaging device IS can include an imaging lens for forming an image on an image sensor. The imaging device IS is located on the outer side surface of a glasses temple. Images are displayed via the optical elements 20.

The head mounted display HMD can include a not-illustrated communication unit. The head mounted display HMD can perform wired communication and/or wireless communication with other devices via the communication unit. The head mounted display HMD may include two display devices DSPL for the left and right eyes. The head mounted display HMD may include two imaging devices IS for the left and right eyes. The imaging and display timing of the imaging devices IS and the display devices DSPL for the left and right eyes can be freely set separately. Specifically, possible operations may include capturing images at the same time and displaying the images at different times, and capturing images at different times and displaying the images at the same time. The imaging devices IS and the display devices DSPL may be located at different positions. The imaging devices IS and the display devices DSPL may be located to overlap on the line of sight.

The present invention is not limited to the foregoing exemplary embodiments, and many modifications can be made without departing from the technical concept of the present invention. The effects described in the exemplary embodiments are merely an enumeration of most suitable effects resulting from the present invention, and the effects of the present invention are not limited to those described in the exemplary embodiments.

The foregoing exemplary embodiments can be modified as appropriate without departing from the technical concept. For example, more than one exemplary embodiment can be combined. Some of the items of at least one exemplary embodiment can be deleted or replaced.

Moreover, new items can be added to at least one exemplary embodiment. Note that the disclosure of this description includes not only what is explicitly described in this description but all items that can be understood from this description and the drawings attached to this description.

Regarding the specific numerical ranges exemplified in this description, a notation e to f (e and f are numbers) means greater than or equal to e and/or less than or equal to f. Regarding the specific numerical ranges exemplified in this description, when a range i to j and a range m to n are specified together (i, j, m, and n are numbers)), the pairs of lower and upper limits are not limited to the pair of i and j or the pair of m and n. For example, the lower and upper limits of the plurality of pairs may be examined in combination. Specifically, when the range i to j and the range m to n are specified together, the range i to n may be examined, or the range m to j may be examined, as long as no contradiction arises. Moreover, e or more means being equal to e or greater than e (exceeding e), and a value greater than e can be adopted without adopting e. Furthermore, for less means being equal to f or less than f (falling below f), and a value less than f can be adopted without adopting f.

Furthermore, the disclosure of this description includes the following items.

### [Item A1]

An optical element including:
a mirror array; and
an optical surface opposed to the mirror array,
wherein the mirror array includes;
a first mirror group including a plurality of retroreflective mirrors arranged in a first direction, and
a second mirror group including a plurality of retroreflective mirrors arranged in the first direction,
wherein the first mirror group and the second mirror group are juxtaposed in a second direction intersecting the first direction,
wherein the plurality of retroreflective mirrors of the first mirror group extends along a third direction that intersects the first and second directions and is oblique to the optical surface,
wherein the plurality of retroreflective mirrors of the second mirror group extends along a fourth direction that intersects the first and second directions and is oblique to the optical surface, and
wherein the first mirror group and the second mirror group overlap in part in a fifth direction orthogonal to the first and third directions.

### [Item A2]

The optical element according to Item A1, wherein the first mirror group and the second mirror group overlap in part in a direction perpendicular to the optical surface.

### [Item A3]

The optical element according to Item A1 or A2, wherein each of the plurality of retroreflective mirrors of the first mirror group and the plurality of retroreflective mirrors of the second mirror group includes a pair of reflecting surfaces that are non-parallel to each other and opposed to each other in the first direction.

### [Item A4]

The optical element according to Item A3,
wherein the first mirror group includes a non-opposed surface not opposed to the pair of reflecting surfaces of at least one of the plurality of retroreflective mirrors of the first mirror group in the first direction, and
wherein the non-opposed surface overlaps the second mirror group in a/the direction perpendicular to the optical surface.

### [Item A5]

The optical element according to any one of Items A1 to A4, wherein an angle formed between the third direction and the optical surface is greater than 20° and less than 45°

### [Item A6]

The optical element according to any one of Items A1 to A5, wherein an angle that a direction connecting an end of the first mirror group on the second mirror group side and an end of the second mirror group on the first mirror group side orthogonally to the first direction forms with the optical surface is greater than 90° and less than 135°

### [Item A7]

The optical element according to any one of Items A1 to A6, wherein an angle that a/the direction connecting an/the end of the first mirror group on the second mirror group side and an/the end of the second mirror group on the first mirror group side orthogonally to the first direction forms with the third direction is greater than 15° and less than 70°

### [Item A8]

The optical element according to any one of Items A1 to A7,
wherein the plurality of retroreflective mirrors of the first mirror group includes a first retroreflective mirror, a second retroreflective mirror, and a third retroreflective mirror that is located between the first retroreflective mirror and the second retroreflective mirror in the first direction, and
wherein a width of the first retroreflective mirror and a width of the second retroreflective mirror in the first direction are greater than that of the third retroreflective mirror in the first direction.

### [Item A9]

The optical element according to any one of Items A1 to A8, wherein a width of the second mirror group in the first direction is greater than that of the first mirror group in the first direction.

### [Item A10]

The optical element according to any one of Items A1 to A9,
wherein a reflective region of the first mirror group has a shape where recesses and protrusions are repeated in the first direction, and the second mirror group has a shape where recesses and protrusions are repeated in the first direction, and
wherein the recesses of the first mirror group and the protrusions of the second mirror group overlap, and the protrusions of the first mirror group and the recesses of the second mirror group overlap, in the fifth direction.

### [Item A11]

The optical element according to any one of Items A1 to A10, wherein a base including the optical surface is configured to support a reflective body of the mirror array.

### [Item A12]

The optical element according to Item A11, wherein the base is formed of at least plastic.

### [Item A13]

The optical element according to Item A12, wherein the plastic is a cycloolefin polymer.

### [Item A14]

The optical element according to any one of Items A11 to A13, wherein the base includes a front surface including the optical surface, a rear surface opposite to the front surface, and a side surface connecting the front surface and the rear surface, and the rear surface has a mold ejector pin mark.

### [Item A15]

The optical element according to any one of Items A11 to A14, wherein the base includes a/the front surface including the optical surface, a/the rear surface opposite to the front surface, and a/the side surface connecting the front surface and the rear surface, and the side surface includes an optical surface.

### [Item A16]

The optical element according to any one of Items A11 to A15, wherein the reflective body contains dielectric material.

### [Item A17]

The optical element according to any one of Items A11 to A16, wherein the reflective body has transparency.

### [Item A18]

The optical element according to any one of Items A11 to A17, including a component configured to cover the mirror array from a side of the mirror array opposite to the optical surface.

### [Item A19]

The optical element according to Item A18, wherein an adhesive member is disposed between the reflective body and the component.

### [Item A20]

The optical element according to Item A18 or A19, wherein the component includes a second optical surface opposed to the mirror array, with the optical surface of the base as a first optical surface.

### [Item A21]

The optical element according to any one of Items A1 to A20, including:
an incident portion on which light is incident; and
a light guide portion configured to guide the light from the incident portion to the mirror array.

### [Item A22]

The optical element according to Item A21, wherein the light guide portion includes a reflecting surface configured to reflect the light by total internal reflection.

### [Item A23]

Equipment including:
the optical element according to any one of Items A1 to A22; and
a display element configured to display an image serving as light to be incident on the optical element.

### [Item A24]

Equipment including:
the optical element according to any one of Items A1 to A22; and
a mounting means configured to mount the optical element on a user's head.

### [Item A25]

The equipment according to Item A23 or A24, including an image sensor configured to capture an/the image to be displayed on the display element.

### [Item B1]

An optical element including:
a mirror array;
a first optical surface opposed to the mirror array; and
a second optical surface opposed to the mirror array,
wherein the mirror array includes a mirror group located between the first optical surface and the second optical surface, the mirror group including a plurality of retroreflective mirrors arranged in a first direction, and
wherein the plurality of retroreflective mirrors of the mirror group extends along a second direction that intersects the first direction and is oblique to the first and second optical surfaces.

### [Item B2]

The optical element according to Item B1, wherein a length of each of the plurality of retroreflective mirrors of the mirror group in the second direction is greater than or equal to twice a width of each of the plurality of retroreflective mirrors in the first direction.

### [Item B3]

The optical element according to Item B1 or B2, wherein a/the length of each of the plurality of retroreflective mirrors of the mirror group in the second direction is less than or equal to 10 times a/the width of each of the plurality of retroreflective mirrors in the first direction.

### [Item B4]

The optical element according to any one of Items B1 to B3, wherein the plurality of retroreflective mirrors has transparency.

### [Item B5]

The optical element according to any one of Items B1 to B4, wherein a distance between the first optical surface and the second optical surface is 1 mm or more and 10 mm or less.

### [Item B6]

The optical element according to any one of Items B1 to B5, wherein a base including the first optical surface is configured to support a reflective body of the mirror array.

### [Item B7]

The optical element according to Item B6, wherein a component including the second optical surface is configured to cover the mirror array from a side of the mirror array opposite to the first optical surface.

### [Item B8]

The optical element according to Item B7, wherein an adhesive member is disposed between the reflective body and the component.

### [Item B9]

The optical element according to Item B7 or B8, wherein the adhesive member is in contact with the base.

### [Item B10]

The optical according to Item B8 or B9,
wherein the adhesive member has a thickness of 1 μm or more and 1 mm or less, and/or
wherein a difference between a refractive index of the adhesive member and that of the component is less than 0.25.

### [Item B11]

The optical element according to any one of Items B7 to B10,
wherein the base and the component are formed of same material, and/or
wherein a difference between a refractive index of the base and that of the component is less than 0.01.

### [Item B12]

The optical element according to any one of Items B6 to B11, wherein the base is formed of at least plastic.

### [Item B13]

The optical element according to Item B12, wherein the reflective body contains inorganic material, and the inorganic material is in contact with the plastic.

### [Item B14]

The optical element according to Item B12 or B13, wherein the plastic is a cycloolefin polymer.

### [Item B15]

The optical element according to any one of Items B6 to B14, wherein a/the component including the second optical surface is configured to cover the mirror array from a/the side of the mirror array opposite to the first optical surface, and the component is formed of at least a cycloolefin polymer.

### [Item B16]

The optical element according to any one of Items B1 to B15, wherein each of the plurality of retroreflective mirrors of the mirror group includes a pair of reflecting surfaces that are non-parallel to each other and opposed to each other in the first direction.

### [Item B17]

The optical element according to any one of Items B1 to B16,
wherein an angle formed between the second direction and the first optical surface is greater than 15° and less than 45°, and
wherein an angle formed between the second direction and the second optical surface is greater than 15° and less than 45°.

### [Item B18]

The optical element according to any one of Items B1 to B17,
wherein with the mirror group as a first mirror group, the mirror array includes a second mirror group located between the first optical surface and the second optical surface, the second mirror group including a plurality of retroreflective mirrors arranged in the first direction,
wherein the plurality of retroreflective mirrors of the second mirror group extends along a third direction that intersects the first direction and is oblique to the first and second optical surfaces, and
wherein the first mirror group and the second mirror group are juxtaposed in a fourth direction intersecting the first direction.

### [Item B19]

The optical element according to any one of Items B6 to B15, wherein the base includes a front surface including the first optical surface, a rear surface opposite to the front surface, and a side surface connecting the front surface and the rear surface, and the rear surface has a mold ejector pin mark.

### [Item B20]

The optical element according to any one of Items B6 to B16, where the base includes a front surface including the first optical surface, a rear surface opposite to the front surface, and a side surface connecting the front surface and the rear surface, and the side surface includes an optical surface.

### [Item B21]

The optical element according to any one of Items B1 to B20, including an incident portion on which light is incident and a light guide portion configured to guide the light from the incident portion to the mirror array.

### [Item B22]

The optical element according to Item B21, wherein the light guide portion includes a reflecting surface configured to reflect the light by total internal reflection.

### [Item B23]

Equipment including:
the optical element according to any one of Items B1 to B22; and
a display element configured to display an image serving as light to be incident on the optical element.

### [Item B24]

Equipment including:
the optical element according to any one of Items B1 to B22; and
a mounting means configured to mount the optical element on a user's head.

### [Item B25]

The equipment according to Item B23 or B24, including an image sensor configured to capture an/the image to be displayed on the display element.

### [Item C1]

An optical element including:
a mirror array; and
an optical surface opposed to the mirror array,
wherein the mirror array includes
a first transparent mirror, and
a second transparent mirror,
wherein the first transparent mirror extends along a first direction oblique to the optical surface,
wherein the second transparent mirror extends along a second direction oblique to the optical surface,
wherein in a third direction intersecting the optical surface and the first direction, the first transparent mirror is located between the second transparent mirror and the optical surface, a first portion of the first transparent mirror and a first portion of the second transparent mirror overlap, a second portion of the first transparent mirror does not overlap the second transparent mirror, and a second portion of the second transparent mirror does not overlap the first transparent mirror, and
wherein at least either that the first portion of the first transparent mirror has a reflectance lower than that of the second portion of the first transparent mirror or that the first portion of the second transparent mirror has a reflectance lower than that of the second portion of the second transparent mirror is satisfied.

### [Item C2]

The optical element according to Item C1, wherein the first portion of the first transparent mirror and the first portion of the second transparent mirror overlap in a direction perpendicular to the optical surface.

### [Item C3]

The optical element according to Item C1 or C2, wherein the reflectance of the second portion of the second transparent mirror is higher than that of the second portion of the first transparent mirror.

### [Item C4]

The optical element according to any one of Items C1 to C3, wherein the first transparent mirror and the second transparent mirror are retroreflective mirrors.

### [Item C5]

The optical element according to any one of Items C1 to C4, wherein each of the first and second transparent mirrors includes a pair of reflecting surfaces that are non-parallel to each other and opposed to each other in the first direction.

### [Item C6]

The optical element according to Item C5,
wherein the first transparent mirror includes a non-opposed surface not opposed to the pair of reflecting surfaces of the first transparent mirror in the first direction, and
wherein the non-opposed surface overlaps the second transparent mirror in a/the direction perpendicular to the optical surface.

### [Item C7]

The optical element according to any one of Items C1 to C6,
wherein the mirror array includes
a first mirror group including a plurality of retroreflective mirrors arranged in a fourth direction intersecting the first direction, and
a second mirror group including a plurality of retroreflective mirrors arranged in the fourth direction,
wherein the first mirror group and the second mirror group are juxtaposed in a fifth direction intersecting the fourth direction,
wherein the plurality of retroreflective mirrors of the first mirror group extends along the first direction,
wherein the plurality of retroreflective mirrors of the second mirror group extends along the second direction,
wherein at least one of the plurality of retroreflective mirrors of the first mirror group is the first transparent mirror, and
wherein at least one of the plurality of retroreflective mirrors of the second mirror group is the second transparent mirror.

### [Item C8]

The optical element according to Item C7,
wherein the plurality of retroreflective mirrors of the first mirror group includes a first retroreflective mirror, a second retroreflective mirror, and a third retroreflective mirror that is located between the first retroreflective mirror and the second retroreflective mirror in the fourth direction, and
wherein a width of the first retroreflective mirror and a width of the second retroreflective mirror in the fourth direction are greater than that of the third retroreflective mirror in the fourth direction.

### [Item C9]

The optical element according to Item C7 or C8, wherein a width of the second mirror group in the fourth direction is greater than that of the first mirror group in the fourth direction.

### [Item C10]

The optical element according to any one of Items C7 to C9,
wherein a reflective region of the first mirror group has a shape where recesses and protrusions are repeated in the fourth direction, and the second mirror group has a shape where recesses and protrusions are repeated in the fourth direction, and
wherein the recesses of the first mirror group and the protrusions of the second mirror group overlap, and the protrusions of the first mirror group and the recesses of the second mirror group overlap, in the third direction.

### [Item C11]

The optical element according to any one of Items C1 to C10, wherein a base including the optical surface is configured to support a reflective body of the mirror array.

### [Item C12]

The optical element according to Item C11, wherein the base is formed of at least plastic.

### [Item C13]

The optical element according to Item C12, wherein the plastic is a cycloolefin polymer.

### [Item C14]

The optical element according to any one of Items C11 to C13, wherein the base includes a front surface including the optical surface, a rear surface opposite to the front surface, and a side surface connecting the front surface and the rear surface, and the rear surface has a mold ejector pin mark.

### [Item C15]

The optical element according to any one of Items C11 to C14, wherein the base includes a/the front surface including the optical surface, a/the rear surface opposite to the front surface, and a/the side surface connecting the front surface and the rear surface, and the side surface includes an optical surface.

### [Item C16]

The optical element according to any one of Items C11 to C15, wherein the reflective body contains dielectric material.

### [Item C17]

The optical element according to any one of Items C1 to C16, wherein the mirror array includes a transparent mirror connecting the first and second transparent mirrors.

### [Item C18]

The optical element according to any one of Items C11 to C17, including a component configured to cover the mirror array from a side of the mirror array opposite to the optical surface.

### [Item C19]

The optical element according to Item C18, wherein an adhesive member is disposed between the reflective body and the component.

### [Item C20]

The optical element according to Item C18 or C19, wherein the component includes a second optical surface opposed to the mirror array, with the optical surface of the base as a first optical surface.

### [Item C21]

The optical element according to any one of Items C1 to C20, including:
an incident portion on which light is incident; and
a light guide portion configured to guide the light from the incident portion to the mirror array.

### [Item C22]

The optical element according to Item C21, wherein the light guide portion includes a reflecting surface configured to reflect the light by total internal reflection.

### [Item C23]

Equipment including:
the optical element according to any one of Items C1 to C22; and
a display element configured to display an image serving as light to be incident on the optical element.

### [Item C24]

Equipment including:
the optical element according to any one of Items C1 to C22; and
a mounting means configured to mount the optical element on a user's head.

### [Item C25]

Equipment according to Item C23 or C24, including an image sensor configured to capture an/the image to be displayed on a/the display element.

[Item D1]

An optical element including:
a mirror array; and
a first optical surface opposed to the mirror array,
wherein the mirror array includes
a first mirror group including a plurality of retroreflective mirrors arranged in a first direction, and
a second mirror group including a plurality of retroreflective mirrors arranged in the first direction,
wherein the first mirror group and the second mirror group are juxtaposed in a second direction intersecting the first direction,
wherein the plurality of retroreflective mirrors of the first mirror group extends along a third direction that intersects the first and second directions and is oblique to the first optical surface,
wherein the plurality of retroreflective mirrors of the second mirror group extends along a fourth direction that intersects the first and second directions and is oblique to the first optical surface, and
wherein the first mirror group and the second mirror group overlap in part in a fifth direction orthogonal to the first and third direction.

### [Item D2]

The optical element according to Item D1, wherein the first mirror group and the second mirror group overlap in part in a direction perpendicular to the first optical surface.

### [Item D3]

The optical element according to Item D1 or D2, wherein each of the plurality of retroreflective mirrors of the first mirror group and the plurality of retroreflective mirrors of the second mirror group includes a pair of reflecting surfaces that are non-parallel to each other and opposed to each other in the first direction.

### [Item D4]

The optical element according to Item D3,
wherein the first mirror group includes a non-opposed surface not opposed to the pair of reflecting surfaces of at least one of the plurality of retroreflective mirrors of the first mirror group in the first direction, and
wherein the non-opposed surface overlaps the second mirror group in a/the direction perpendicular to the first optical surface.

### [Item D5]

The optical element according to any one of Items D1 to D4, wherein an angle formed between the third direction and the first optical surface is greater than 20° and less than 45°

### [Item D6]

The optical element according to any one of Items D1 to D5, wherein an angle that a direction connecting an end of the first mirror group on the second mirror group side and an end of the second mirror group on the first mirror group side orthogonally to the first direction forms with the optical surface is greater than 90° and less than 135°.

### [Item D7]

The optical element according to any one of Items D1 to D6, wherein an angle that a/the direction connecting an/the end of the first mirror group on the second mirror group side and an/the end of the second mirror group on the first mirror group side orthogonally to the first direction forms with the third direction is greater than 15° and less than 70°.

### [Item D8]

The optical element according to any one of Items D1 to D7,
wherein the plurality of retroreflective mirrors of the first mirror group includes a first retroreflective mirror, a second retroreflective mirror, and a third retroreflective mirror that is located between the first retroreflective mirror and the second retroreflective mirror in the first direction, and
wherein a width of the first retroreflective mirror and a width of the second retroreflective mirror in the first direction are greater than that of the third retroreflective mirror in the first direction.

### [Item D9]

The optical element according to any one of Items D1 to D8, wherein a width of the second mirror group in the first direction is greater than that of the first mirror group in the first direction.

### [Item D10]

The optical element according to any one of Items D1 to D9,
wherein a reflective region of the first mirror group has a shape where recesses and protrusions are repeated in the first direction, and the second mirror group has a shape where recesses and protrusions are repeated in the first direction, and
wherein the recesses of the first mirror group and the protrusions of the second mirror group overlap, and the protrusions of the first mirror group and the recesses of the second mirror group overlap, in the fifth direction.

### [Item D11]

An optical element including:
a mirror array;
a first optical surface opposed to the mirror array; and
a second optical surface opposed to the mirror array,
wherein the mirror array includes a mirror group located between the first optical surface and the second optical surface, the mirror group including a plurality of retroreflective mirrors arranged in a first direction, and
wherein the plurality of retroreflective mirrors of the mirror group extends along a second direction that intersects the first direction and is oblique to the first and second optical surfaces.

### [Item D12]

The optical element according to Item D11, wherein a length of each of the plurality of retroreflective mirrors of the mirror group in the second direction is greater than or equal to twice a width of each of the plurality of retroreflective mirrors in the first direction.

### [Item D13]

The optical element according to Item D11 or D12, wherein a/the length of each of the plurality of retroreflective mirrors of the mirror group in the second direction is less than or equal to 10 times a/the width of each of the retroreflective mirrors in the first direction.

### [Item D14]

The optical element according to any one of Items D1 to D13, wherein the plurality of retroreflective mirrors has transparency.

### [Item D15]

The optical element according to any one of Items D11 to D14, wherein a distance between the first optical surface and the second optical surface is 1 mm or more and 10 mm or less.

### [Item D16]

The optical element according to any one of Items D11 to D14,
wherein a base including the first optical surface is configured to support a reflective body of the mirror array, and
wherein a component including the second optical surface is configured to cover the mirror array from a side of the mirror array opposite to the first optical surface.

### [Item D17]

The optical element according to Item D16,
wherein the base and the component are formed of same material, and/or
wherein a difference between a refractive index of the base and that of the components is 0.01 or less.

### [Item D18]

The optical element according to any one of Items D11 to D14, wherein each of the plurality of retroreflective mirrors of the mirror group includes a plurality of reflecting surfaces that are non-parallel to each other and opposed to each other in the first direction.

### [Item D19]

The optical element according to any one of Items D11 to D14,
wherein an angle formed between the second direction and the first optical surface is greater than 15° and less than 45°, and
wherein an angle formed between the second direction and the second optical surface is greater than 15° and less than 45°.

### [Item D20]

The optical element according to any one of Items D11 to D14,
wherein with the mirror group as a first mirror group, the mirror array includes a second mirror group located between the first optical surface and the second optical surface, the second mirror group including a plurality of retroreflective mirrors arranged in the first direction,
wherein the plurality of retroreflective mirrors of the second mirror group extends along a third direction that intersects the first direction and is oblique to the first and second optical surfaces, and
wherein the first mirror group and the second mirror group are juxtaposed in a fourth direction intersecting the first direction.

### [Item D21]

An optical element including:
a mirror array; and
a first optical surface opposed to the mirror array,
wherein the mirror array includes
a first transparent mirror, and
a second transparent mirror,
wherein the first transparent mirror extends along a first direction oblique to the first optical surface,
wherein the second transparent mirror extends along a second direction oblique to the first optical surface,
wherein in a third direction intersecting the first optical surface and the first direction, the first transparent mirror is located between the second transparent mirror and the first optical surface, a first portion of the first transparent mirror and a first portion of the second transparent mirror overlap, a second portion of the first transparent mirror does not overlap the second transparent mirror, and a second portion of the second transparent mirror does not overlap the first transparent mirror, and
wherein at least either that the first portion of the first transparent mirror has a reflectance lower than that of the second portion of the first transparent mirror or that the first portion of the second transparent mirror has a reflectance lower than that of the second portion of the second transparent mirror is satisfied.

### [Item D22]

The optical element according to Item D21, wherein the first portion of the first transparent mirror and the first portion of the second transparent mirror overlap in a direction perpendicular to the first optical surface.

### [Item D23]

The optical element according to Item D21 or D22, wherein the reflectance of the second portion of the second transparent mirror is higher than that of the second portion of the first transparent mirror.

### [Item D24]

The optical element according to any one of Items D21 to D23, wherein the first transparent mirror and the second transparent mirror are retroreflective mirrors.

### [Item D25]

The optical element according to any one of Items D21 to D24, wherein each of the first and second transparent mirrors includes a pair of reflecting surfaces that are non-parallel to each other and opposed to each other in the first direction.

### [Item D26]

The optical element according to Item D25,
wherein the first transparent mirror includes a non-opposed surface not opposed to the pair of reflecting surfaces of the first transparent mirror in the first direction, and
wherein the non-opposed surface overlaps the second transparent mirror in a/the direction perpendicular to the first optical surface.

### [Item D27]

The optical element according to any one of Items D21 to D26,
wherein the mirror array includes
a first mirror group including a plurality of retroreflective mirrors arranged in a fourth direction intersecting the first direction, and
a second mirror group including a plurality of retroreflective mirrors arranged in the fourth direction,
wherein the first mirror group and the second mirror group are juxtaposed in a fifth direction intersecting the fourth direction,
wherein the plurality of retroreflective mirrors of the first mirror group extends along the first direction,
wherein the plurality of retroreflective mirrors of the second mirror group extends along the second direction,
wherein at least one of the plurality of retroreflective mirrors of the first mirror group is the first transparent mirror, and
wherein at least one of the plurality of retroreflective mirrors of the second mirror group is the second transparent mirror.

### [Item D28]

The optical element according to any one of Items D1 to D27, wherein a/the base including the first optical surface is configured to support a/the reflective body of the mirror array.

### [Item D29]

The optical element according to Item D28, wherein the base is formed of at least plastic.

### [Item D30]

The optical element according to Item D29, wherein the plastic is a cycloolefin polymer.

### [Item D31]

The optical element according to Item D29 or D30, wherein the reflective body contains inorganic material, and the inorganic material is in contact with the plastic.

### [Item D32]

The optical element according to any one of Items D28 to D31, wherein the base includes a front surface including the first optical surface, a rear surface opposite to the front surface, and a side surface connecting the front surface and the rear surface, and the rear surface has a mold ejector pin mark.

### [Item D33]

The optical element according to any one of Items D28 to D32, wherein the base includes a/the front surface including the first optical surface, a/the rear surface opposite to the front surface, and a/the side surface connecting the front surface and the rear surface, and the side surface includes an optical surface.

### [Item D34]

The optical element according to any one of Items D28 to D33, wherein the reflective body contains dielectric material.

### [Item D35]

The optical element according to any one of Items D21 to D27, wherein the mirror array includes a transparent mirror connecting the first and second transparent mirrors.

### [Item D36]

The optical element according to any one of Items D28 to D35, including a component configured to cover the mirror array from a side of the mirror array opposite to the first optical surface.

### [Item D37]

The optical element according to Item D36,
wherein the base is formed of at least a cycloolefin polymer, and
wherein the component is formed of at least a cycloolefin polymer.

### [Item D38]

The optical element according to Item D36, wherein an adhesive member is disposed between the reflective body and the component.

### [Item D39]

The optical element according to Item D38,
wherein the adhesive member has a thickness of 1 μm or more and 1 mm or less, and/or
wherein a difference between a refractive index of the adhesive member and that of the component is less than 0.25.

### [Item D40]

The optical element according to any one of Items D36 to D39, wherein the component includes a second optical surface opposed to the mirror array.

### [Item D41]

The optical element according to any one of Items D1 to D40, including:
an incident portion on which light is incident; and
a light guide portion configured to guide the light from the incident portion to the mirror array.

### [Item D42]

The optical element according to Item D41, wherein the light guide portion includes a reflecting surface configured to reflect the light by total internal reflection.

### [Item D43]

Equipment including:
the optical element according to any one of Items D1 to D42; and
a display element configured to display an image serving as light to be incident on the optical element.

### [Item D44]

Equipment including:
the optical element according to any one of Items D1 to D42; and
a mounting means configured to mount the optical element on a user's head.

### [Item D45]

The equipment according to Item D43 or D44, including an image sensor configured to capture an/the image to be displayed on the display element.

The disclosure of this description also includes complementary sets of the individual concepts described in this description. More specifically, for example, when this description states that “A is B”, this description can be said to disclose that “A is not B” even if the statement “A is not B” is omitted. The reason is that when “A is B” is stated, it is premised that the case where “A is not B” has been considered.

The present invention is not limited to the foregoing exemplary embodiments, and various changes and modifications can be made without departing from the spirit and scope of the present invention. The following claims are therefore attached to make the scope of the present invention public.

According to the present invention, a technique advantageous for implementing a compact optical element with high optical performance can be provided.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. An optical element comprising:
a mirror array; and
a first optical surface opposed to the mirror array,
wherein the mirror array includes
a first mirror group including a plurality of retroreflective mirrors arranged in a first direction, and
a second mirror group including a plurality of retroreflective mirrors arranged in the first direction,
wherein the first mirror group and the second mirror group are juxtaposed in a second direction intersecting the first direction,
wherein the plurality of retroreflective mirrors of the first mirror group extends along a third direction that intersects the first and second directions and is oblique to the first optical surface,
wherein the plurality of retroreflective mirrors of the second mirror group extends along a fourth direction that intersects the first and second directions and is oblique to the first optical surface, and
wherein the first mirror group and the second mirror group overlap in part in a fifth direction orthogonal to the first and third directions.

2. The optical element according to claim 1, wherein the first mirror group and the second mirror group overlap in part in a direction perpendicular to the first optical surface.

3. The optical element according to claim 1, wherein each of the plurality of retroreflective mirrors of the first mirror group and the plurality of retroreflective mirrors of the second mirror group includes a pair of reflecting surfaces that are non-parallel to each other and opposed to each other in the first direction.

4. The optical element according to claim 3,
wherein the first mirror group includes a non-opposed surface not opposed to the pair of reflecting surfaces of at least one of the plurality of retroreflective mirrors of the first mirror group in the first direction, and
wherein the non-opposed surface overlaps the second mirror group in a direction perpendicular to the first optical surface.

5. The optical element according to claim 1, wherein an angle formed between the third direction and the first optical surface is greater than 20° and less than 45°.

6. The optical element according to claim 2,
wherein an angle that a direction connecting an end of the first mirror group on the second mirror group side and an end of the second mirror group on the first mirror group side orthogonally to the first direction forms with the first optical surface is greater than 90° and less than 135°, and/or
wherein an angle that a direction connecting an end of the first mirror group on the second mirror group side and an end of the second mirror group on the first mirror group side orthogonally to the first direction forms with the third direction is greater than 15° and less than 70°.

7. The optical element according to claim 1, wherein a base including the optical surface is configured to support a reflective body of the mirror array,
wherein the base includes a front surface including the first optical surface, a rear surface opposite to the front surface, and a side surface connecting the front surface and the rear surface, the rear surface has a mold ejector pin mark, and the rear surface includes an optical surface.

8. The optical element according to claim 2,
wherein the plurality of retroreflective mirrors of the first mirror group includes a first retroreflective mirror, a second retroreflective mirror, and a third retroreflective mirror that is located between the first retroreflective mirror and the second retroreflective mirror in the first direction, and
wherein a width of the first retroreflective mirror and a width of the second retroreflective mirror in the first direction are greater than that of the third retroreflective mirror in the first direction.

9. The optical element according to claim 1, wherein a width of the second mirror group in the first direction is greater than that of the first mirror group in the first direction.

10. The optical element according to claim 1,
wherein a reflective region of the first mirror group has a shape where recesses and protrusions are repeated in the first direction, and the second mirror group has a shape where recesses and protrusions are repeated in the first direction, and
wherein the recesses of the first mirror group and the protrusions of the second mirror group overlap, and the protrusions of the first mirror group and the recesses of the second mirror group overlap, in the fifth direction.

11. An optical element comprising:
a mirror array;
a first optical surface opposed to the mirror array; and
a second optical surface opposed to the mirror array,
wherein the mirror array includes a mirror group located between the first optical surface and the second optical surface, the mirror group including a plurality of retroreflective mirrors arranged in a first direction, and
wherein the plurality of retroreflective mirrors of the mirror group extends along a second direction that intersects the first direction and is oblique to the first and second optical surfaces.

12. The optical element according to claim 11, wherein a length of each of the plurality of retroreflective mirrors of the mirror group in the second direction is greater than or equal to twice a width of each of the plurality of retroreflective mirrors in the first direction.

13. The optical element according to claim 12, wherein the length of each of the plurality of retroreflective mirrors of the mirror group in the second direction is less than or equal to 10 times the width of each of the plurality of retroreflective mirrors in the first direction.

14. The optical element according to claim 11, wherein the plurality of retroreflective mirrors has transparency.

15. The optical element according to claim 11, wherein a distance between the first optical surface and the second optical surface is 1 mm or more and 10 mm or less.

16. The optical element according to claim 11,
wherein a base including the first optical surface is configured to support a reflective body of the mirror array, and
wherein a component including the second optical surface is configured to cover the mirror array from a side of the mirror array opposite to the first optical surface.

17. The optical element according to claim 16,
wherein the base and the component are formed of same material, and/or
wherein a difference between a refractive index of the base and that of the component is 0.01 or less.

18. The optical element according to claim 11, wherein each of the plurality of retroreflective mirrors of the mirror group includes a pair of reflecting surfaces that are non-parallel to each other and opposed to each other in the first direction.

19. The optical element according to claim 11,
wherein an angle formed between the second direction and the first optical surface is greater than 15° and less than 45°, and
wherein an angle formed between the second direction and the second optical surface is greater than 15° and less than 45°.

20. The optical element according to claim 11,
wherein with the mirror group as a first mirror group, the mirror array includes a second mirror group located between the first optical surface and the second optical surface, the second mirror group including a plurality of retroreflective mirrors arranged in the first direction,
wherein the plurality of retroreflective mirrors of the second mirror group extends along a third direction that intersects the first direction and is oblique to the first and second optical surfaces, and
wherein the first mirror group and the second mirror group are juxtaposed in a fourth direction intersecting the first direction.

21. An optical element comprising:
a mirror array; and
a first optical surface opposed to the mirror array,
wherein the mirror array includes
a first transparent mirror, and
a second transparent mirror,
wherein the first transparent mirror extends along a first direction oblique to the first optical surface,
wherein the second transparent mirror extends along a second direction oblique to the first optical surface,
wherein in a third direction intersecting the first optical surface and the first direction, the first transparent mirror is located between the second transparent mirror and the first optical surface, a first portion of the first transparent mirror and a first portion of the second transparent mirror overlap, a second portion of the first transparent mirror does not overlap the second transparent mirror, a second portion of the second transparent mirror does not overlap the first transparent mirror, and a third portion of the first transparent mirror and a third portion of the second transparent mirror overlap, and
wherein at least either that the first portion of the first transparent mirror has a reflectance lower than that of the second portion of the first transparent mirror and that of the second portion of the second transparent mirror and that of the third portion of the first transparent mirror or that the first portion of the second transparent mirror has a reflectance lower than that of the second portion of the first transparent mirror and that of the second portion of the second transparent mirror and that of the third portion of the second transparent mirror is satisfied.

22. The optical element according to claim 21, wherein the first portion of the first transparent mirror and the first portion of the second transparent mirror overlap in a direction perpendicular to the first optical surface.

23. The optical element according to claim 21, wherein the reflectance of the second portion of the second transparent mirror is higher than that of the second portion of the first transparent mirror.

24. The optical element according to claim 21, the first transparent mirror and the second transparent mirror are retroreflective mirrors.

25. The optical element according to claim 21, wherein each of the first and second transparent mirrors includes a pair of reflecting surfaces that are non-parallel to each other and opposed to each other in the first direction.

26. The optical element according to claim 25,
wherein the first transparent mirror includes a non-opposed surface not opposed to the pair of reflecting surfaces of the first transparent mirror in the first direction, and
wherein the non-opposed surface overlaps the second transparent mirror in a direction perpendicular to the first optical surface.

27. The optical element according to claim 21,
wherein the mirror array includes
a first mirror group including a plurality of retroreflective mirrors arranged in a fourth direction intersecting the first direction, and
a second mirror group including a plurality of retroreflective mirrors arranged in the fourth direction,
wherein the first mirror group and the second mirror group are juxtaposed in a fifth direction intersecting the fourth direction,
wherein the plurality of retroreflective mirrors of the first mirror group extends along the first direction,
wherein the plurality of retroreflective mirrors of the second mirror group extends along the second direction,
wherein at least one of the plurality of retroreflective mirrors of the first mirror group is the first transparent mirror, and
wherein at least one of the plurality of retroreflective mirrors of the second mirror group is the second transparent mirror.

28. Equipment comprising:
the optical element according to claim 1; and
a display element configured to display an image serving as light to be incident on the optical element.

29. Equipment comprising:
the optical element according to claim 11; and
a mounting means configured to mount the optical element on a user's head.

30. Equipment comprising:
the optical element according to claim 21;
a display element configured to display an image serving as light to be incident on the optical element; and
an image sensor configured to capture the image to be displayed on the display element.
